(19) United States
(12) Patent Application Publication
(10) Pub. No.: US 2023/0219423 A1
(43) Pub. Date: Jul. 13, 2023

(54) SYSTEM AND METHOD FOR DETERMINING A SUITABLE BATTERY PACK COMBINATION CONFIGURED FOR USE IN AN ELECTRIC AIRCRAFT

(71) Applicant: BETA AIR, LLC, SOUTH BURLINGTON, VT (US)

(72) Inventors: John Charles Palombini, SOUTH BURLINGTON, VT (US); Steven J. Foland, SOUTH BURLINGTON, VT (US)

(73) Assignee: BETA AIR, LLC, SOUTH BURLINGTON, VT (US)

(21) Appl. No.: 18/095,266

(22) Filed: Jan. 10, 2023

Related U.S. Application Data
(63) Continuation-in-part of application No. 17/575,105, filed on Jan. 13, 2022, now Pat. No. 11,584,250.

(51) Int. Cl. B60L 3/00; B60L 58/18; B64F 5/60; G06N 20/00

(52) U.S. Cl. CPC B60L 3/0046; B60L 58/18; B64F 5/60; G06N 20/00; B60L 2200/10; B64C 29/0008

(57) ABSTRACT

A system and method for its use for determining a suitable battery pack combination configured for use in an electric aircraft, the system including at least a processor connected to a sensor and a memory containing instructions configuring the at least a processor to receive battery pack status data for each battery pack of a plurality of battery packs, generate a battery pack diagnostic datum for each battery pack of the plurality of battery packs as a function of the battery pack status data of each battery pack of the plurality of battery packs, and determine a suitability of the plurality of battery packs as a function of each battery pack diagnostic datum for each battery pack of the plurality of battery packs.

### CROSS-REFERENCE TO RELATED APPLICATIONS

This application is a continuation-in-part of Non-provisional application Ser. No. 17/575,105, filed on Jan. 13, 2022 and entitled “CHARGING STATION FOR TRANSFERRING POWER BETWEEN AN ELECTRIC AIRCRAFT AND A POWER GRID,” the entirety of which is incorporated herein by reference.

### FIELD OF THE INVENTION

The present invention generally relates to the field of electric vehicles. In particular, the present invention is directed to system and method for determining a suitable battery pack combination configured for use in an electric aircraft.

### BACKGROUND

In electrically propelled vehicles, such as an electric vertical takeoff and landing (eVTOL) aircraft, it is essential to maintain the integrity of the aircraft until safe landing. In some flights, a component of the aircraft may experience a malfunction or failure which will put the aircraft in an unsafe mode which will compromise the safety of the aircraft, passengers, and onboard cargo. One of the factors for such malfunction or failure may include usage of one or more unhealthy batteries as power source for electric vehicles. As constant use of the battery results in a gradual degradation of the battery's maximum capacity and various performances, the electric vehicle may experience reduced performance qualities that may compromise the safety of all personnel and cargo of the electric vehicle. It is not cost effective to replace the entire power source of the electric vehicle.

### SUMMARY OF THE DISCLOSURE

In an aspect, a system for determining a suitable battery pack combination configured for use in an electric aircraft the system including at least a processor configured to be communicative with the at least a sensor and a memory communicatively connected to the at least a processor containing instructions configuring the at least a processor to receive battery pack status data associated with each battery pack of a plurality of battery packs, generate a battery pack diagnostic datum for each battery pack of the plurality of battery packs as a function of the battery pack status data of each battery pack of the plurality of battery packs, and determine a suitability of the plurality of battery packs as a function of each battery pack diagnostic datum for each battery pack of the plurality of battery packs.

In another aspect, a method for determining a suitable battery pack combination configured for use in an electric aircraft, the method including receiving, by at least a processor, battery pack status data for each battery pack of a plurality of battery packs, generating, by the at least a processor, a battery pack diagnostic datum for each battery pack of the plurality of battery packs as a function of the battery pack status data of each battery pack of the plurality of battery packs, and determining, by the at least a processor, a suitability of the plurality of battery packs as a function of each battery pack diagnostic datum for each battery pack of the plurality of battery packs.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a box diagram illustrating a system for determining a suitable battery pack combination;

FIG. 2 is an illustration of an exemplary embodiment of an electric aircraft;

FIG. 3 is a schematic illustration of an exemplary battery pack;

FIG. 4 is an illustration of a sensor suite in partial cut-off view;

FIG. 5 is a block diagram of an exemplary flight controller;

FIG. 6 is a block diagram of an exemplary embodiment of a machine learning module;

FIG. 7 is an exemplary method for determining a suitable battery pack combination configured for use in an electric aircraft; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for determining an optimal battery pack combination configured for use in an electric aircraft including a plurality of battery packs, wherein each battery pack including at least a battery module containing at least a battery cell, and at least a sensor configured to detect battery pack status data corresponding to the plurality of battery packs, the system including at least a processor configured to be communicative with the at least a sensor and a memory communicatively connected to the at least a processor containing instructions configuring the at least a processor to receive battery pack status data from the at least a sensor, generate a battery pack diagnostic datum for each battery pack of the plurality of battery packs as a function of the battery pack status data of each battery pack of the plurality of battery packs, and determine a suitability of the plurality of battery packs as a function of each battery pack diagnostic datum for each battery pack of the plurality of battery packs. Exemplary embodiments illustrating aspects of the present disclosure are described below in the context of several specific examples.

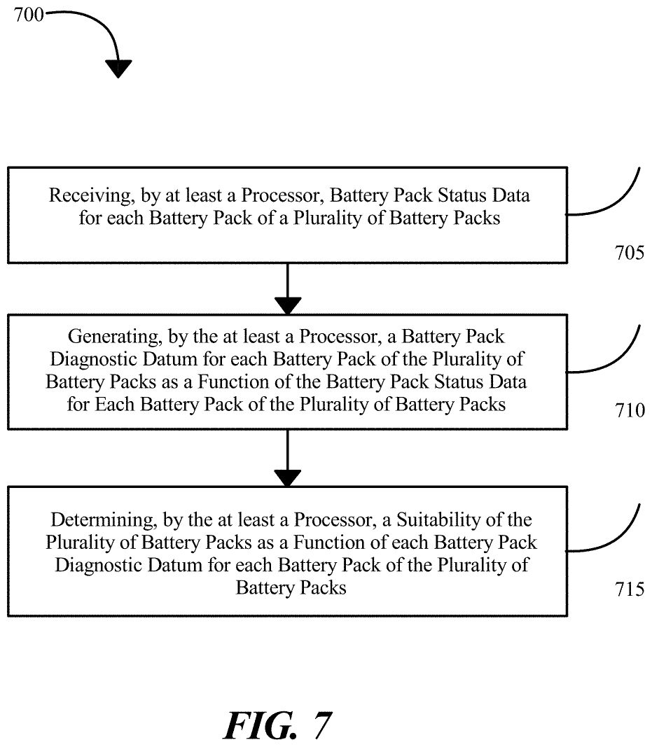

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 7. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

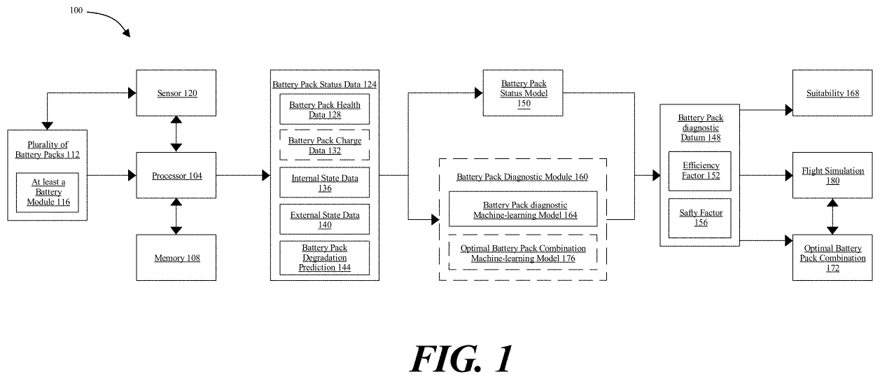

Referring now to FIG. 1, an exemplary embodiment of a system 100 for determining a suitable battery pack combination configured for use in an electric aircraft is illustrated. System includes a processor 104 and a memory 108 communicatively connected to the processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of system 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, as used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, system 100 includes a plurality of battery packs 112, wherein each battery pack 112 includes at least one battery module 116. A “battery pack,” for the purpose of this disclosure, is a set of any number of individual battery modules 116 or identical battery modules. A “battery module”, for the purpose of this disclosure, is a source of electric power consisting of one or more electrochemical cells. Battery pack 112 may include a plurality of battery cells. In a non-limiting embodiment, battery module 116 may include a battery cell and/or a plurality of battery cells. In a non-limiting embodiment, battery module 116 may be electrically connected to another battery module of a plurality of battery modules. “Electrical connection,” for the purpose of this disclosure, is a link that allows the transfer of electrical energy from one electric device to another. For example, and without limitation, battery modules 116 may work in tandem with each to power a flight component. For example, and without limitation, a battery module may compensate for a faulty battery module. In a non-limiting embodiment, battery module 116 may include at least a cell, such as a chemoelectrical, photo electric, or fuel cell. Battery pack 112 may include, without limitation, a generator, a photovoltaic device, a fuel cell such as a hydrogen fuel cell, direct methanol fuel cell, and/or solid oxide fuel cell, or an electric energy storage device; electric energy storage device may include without limitation a capacitor, an inductor, an energy storage cell and/or a battery. Plurality of battery packs 112 may be capable of providing sufficient electrical power for auxiliary loads, including without limitation lighting, navigation, communications, de-icing, steering, or other systems requiring power or energy. Plurality of battery packs 112 may be capable of providing sufficient power for controlled descent and landing protocols, including without limitation hovering descent or runway landing. Plurality of battery packs 112 may include a device for which power that may be produced per unit of volume and/or mass has been optimized, at the expense of the maximal total specific energy density or power capability, during design. Plurality of battery packs 112 may be used, in an embodiment, to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations. In a non-limiting embodiment, battery pack 112 may include a plurality of electrochemical cells. In a non-limiting embodiment, battery pack 112 may be configured to deliver electrical power to a plurality of electrical systems of an electric aircraft. In a non-limiting embodiment, each battery pack 112 of the plurality of battery packs may work in tandem to provide electrical energy to a plurality of electrical systems of an electric aircraft. For example, and without limitation, battery pack 112 may be used to power a flight component or a set of flight components. For example, and without limitation, each battery pack 112 may be used to power unique flight components or a unique set of flight components. A “flight component”, for the purposes of this disclosure, is any component related to, and mechanically connected to an aircraft that manipulates a fluid medium to propel and maneuver the aircraft through the fluid medium. For example, and without limitation, a flight component may include propellers, vertical propulsors, forward pushers, landing gears, rudders, motors, rotors, and the like thereof. Battery pack 112 may include a battery management system integrated into the battery pack. For instance, and without limitation, battery management system may be consistent with the disclosure of any battery management system in U.S. patent application Ser. No. 17/128,798 and title SYSTEMS AND METHODS FOR A BATTERY MANAGEMENT SYSTEM INTEGRATED IN A BATTERY PACK CONFIGURED FOR USE IN ELECTRIC AIRCRAFT,” which is incorporated herein by reference in its entirety. Persons skilled in the art, upon reviewing the entirety of this disclosure, will be aware of the various flight components that may represent battery pack 112 consistently with this disclosure.

With continued reference to FIG. 1, system 100 includes at least a sensor 120 communicatively connected to processor 104. A “sensor,” for the purposes of this disclosure, is an electronic device configured to detect, capture, measure, or combination thereof, a plurality of electric vehicle component quantities. In a non-limiting example, system 100 may include a pack monitor unit (PMU) configured to capture information regarding to plurality of battery pack 112, wherein the PMU may include at least a sensor 120. Pack monitor unit as described herein may be consistent with any pack monitor unit described in U.S. patent application Ser. No. 17/524,265, filed on Nov. 11, 2021, and titled, “SYSTEMS AND METHODS FOR PREDICTING DEGRADATION OF A BATTERY FOR USE IN AN ELECTRIC VEHICLE,” which is incorporated herein in its entirety by reference. In some embodiments, at least a sensor 120 may include a plurality of sensors in the form of individual sensors or a sensor suite working in tandem or individually. In non-limiting example, at least a sensor 120 may include sensors described below in this disclosure or other nondisclosed sensors alone or in combination. In some embodiments, at least a sensor 120 may include a photodiode configured to convert light, heat, electromagnetic elements, and the like thereof, into electrical current for further analysis and/or manipulation. At least a sensor 120 may include circuitry or electronic components configured to digitize, transform, or otherwise manipulate electrical signals. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. The plurality of datum captured by the sensor may include circuitry, computing devices, electronic components, or a combination thereof that translates into at least an electronic signal configured to be transmitted to another electronic component. At least a sensor 120 may be disposed in or on at least a portion of battery pack 112. At least a sensor 120 may be mechanically and communicatively connected consistent with the entirety of this disclosure to one or more portions of battery pack 112. In a non-limiting example, at least a sensor 120 may be disposed inside of battery pack configured to capture one or more datum related to battery module 116 within battery pack 112, such as, without limitation, internal/external state datum described in further detail below.

With continued reference to FIG. 1, at least a sensor 120 may include a proximity sensor. For the purposes of this disclosure, a “proximity sensor” is a device configured to detect the distance of one or more objects from the sensor. One of ordinary skill in the art, after reviewing the entirety of this disclosure, would be aware of multiple types, implementations, and uses for a proximity sensor including measuring the distance to a sensor from an object, measuring the rate of change of distance of an object from a sensor, or triggering one or more other circuits as a function of a detection from said proximity circuit, among a plurality of others. System 100 may include more than one proximity sensor configured to detect a distance, change in distance, threshold distance, or a combination thereof of one or more components integral to battery pack 112. Proximity sensor may be a sensor able to detect the presence of nearby objects without any physical contact. Proximity sensor may emit an electromagnetic field or a beam of electromagnetic radiation such as infrared, for instance, and looks for changes in the field or a return signal. The object, or portion of battery pack 112 or portion of battery module 116, being sensed may be referred to as the proximity sensor target. Different proximity sensor targets demand different sensors. For example, a capacitive proximity sensor or photoelectric sensor might be suitable for a plastic target; an inductive proximity sensor always requires a metal target. Proximity sensor may include a capacitive proximity sensor, a capacitive proximity sensor may be based on capacitive coupling, that can detect and measure anything that is conductive or has a dielectric different from air. Proximity sensor may include projected capacitive touch (PCT) technology, which is a capacitive technology which allows more accurate and flexible operation, by etching the conductive layer. A grid is formed either by etching one layer to form a grid pattern of electrodes, or by etching two separate, parallel layers of conductive material with perpendicular lines or tracks to form the grid; comparable to the pixel grid found in many liquid crystal displays (LCD). The greater resolution of PCT allows operation with no direct contact, such that the conducting layers can be coated with further protective insulating layers, and operate even under screen protectors, or behind weather and vandal-proof glass. Because the top layer of a PCT is glass, PCT is a more robust solution versus resistive touch technology. PCT may include a self-capacitance and/or mutual capacitance. For the purposes of this disclosure, “mutual capacitive” sensors have a capacitor at each intersection of each row and each column. A 12-by-16 array, for example, would have 192 independent capacitors. A voltage is applied to the rows or columns. Bringing a finger or conductive stylus near the surface of the sensor changes the local electric field which reduces the mutual capacitance. The capacitance change at every individual point on the grid can be measured to accurately determine the touch location by measuring the voltage in the other axis. Mutual capacitance allows multi-touch operation where multiple fingers, palms or styli can be accurately tracked at the same time. for the purposes of this disclosure, “self-capacitance” sensors can have the same X-Y grid as mutual capacitance sensors, but the columns and rows operate independently. With self-capacitance, current senses the capacitive load of a finger on each column or row. This produces a stronger signal than mutual capacitance sensing, but it is unable to resolve accurately more than one finger, which results in “ghosting”, or misplaced location sensing. Proximity sensor may have a high reliability and long functional life because of the absence of mechanical parts and lack of physical contact between the sensor and the sensed object. Proximity sensor may also be used to detect machine vibration monitoring to measure the variation in distance between a shaft and its support bearing or any two or more battery packs 112 including battery module 116 within battery packs 112. Proximity sensor may include a photoelectric sensor. A photoelectric sensor may be a device used to determine the distance, absence, or presence of an object by using a light transmitter, often infrared and a photoelectric receiver. Proximity sensor may include opposed (through-beam), retro-reflective, and proximity-sensing (diffused) types of proximity sensors. A through-beam arrangement may consist of a receiver located within the line-of-sight of the transmitter. In this mode, an object may be detected when the light beam is blocked from getting to the receiver from the transmitter. A retroreflective arrangement may place the transmitter and receiver at the same location and uses a reflector to bounce the inverted light beam back from the transmitter to the receiver. An object may be sensed when the beam is interrupted and fails to reach the receiver. A proximity-sensing (diffused) arrangement may be one in which the transmitted radiation must reflect off the object to reach the receiver. In this mode, an object is detected when the receiver sees the transmitted source rather than when it fails to see it. As in retro-reflective sensors, diffuse sensor emitters and receivers may be in the same housing. But the target acts as the reflector so that detection of light is reflected off the disturbance object. The emitter may send out a beam of light (most often a pulsed infrared, visible red, or laser) that diffuses in all directions, filling a detection area. The target may then enter the area and deflect part of the beam back to the receiver. Detection occurs and output is turned on or off when sufficient light falls on the receiver. Some photo-eyes have two different operational types, light operate and dark operate. The light operates photo eyes become operational when the receiver “receives” the transmitter signal. Dark operates photo eyes become operational when the receiver “does not receive” the transmitter signal. The detecting range of a photoelectric sensor may be its “field of view”, or the maximum distance from which the sensor can retrieve information, minus the minimum distance. A minimum detectable object is the smallest object the sensor can detect. More accurate sensors can often have minimum detectable objects of minuscule size. Proximity sensor may include an electromagnetic induction sensor configured to use the principle of electromagnetic induction to detect or measure objects. An inductor develops a magnetic field when a current flows through it; alternatively, a current will flow through a circuit containing an inductor when the magnetic field through it changes. This effect can be used to detect metallic objects that interact with a magnetic field. Non-metallic substances such as liquids or some kinds of dirt do not interact with the magnetic field, so an inductive sensor can operate in wet or dirty conditions which may arise in or on battery packs 112 and/or battery modules 116. Proximity sensor as described herein may be consistent with any proximity sensor described in U.S. Pat. No. 11,340,308, and filed on Apr. 27, 2021, and titled, “SYSTEM AND METHOD FOR STATE DETERMINATION OF A BATTERY MODULE CONFIGURED FOR USED IN AN ELECTRIC VEHICLE”, which is incorporated herein in its entirety by reference.

With continued reference to FIG. 1, at least a sensor 120 may include a pressure sensor. A pressure sensor may include, without limitation, a device for pressure measurement of gases or liquids. A pressure sensor may act as a transducer; it generates a signal as a function of the pressure imposed. For the purposes of this disclosure, such a signal may be electrical and consistent with the description of electrical signals herein. Pressure sensors can also be used to indirectly measure other variables such as fluid/gas flow, speed, water level, and altitude. Pressure sensors can alternatively be called pressure transducers, pressure transmitters, pressure senders, pressure indicators, piezometers and manometers, among other names. There is also a category of pressure sensors that are designed to measure in a dynamic mode for capturing very high-speed changes in pressure, which may be used. In a non-limiting example, at least a sensor 120 may include a load cell. A load cell may be a force transducer. It may convert a force such as tension, compression, pressure, or torque into an electrical signal that can be measured and standardized. At least a sensor 120 may, in a load cell embodiment measure the force of one or more expanding or contracting elements included by battery pack 112 and at least a battery module 116. As the force applied to the load cell increases, the electrical signal changes proportionally. Load cell may be strain gauges, pneumatic, hydraulic, and the like.

With continued reference to FIG. 1, at least a sensor 120 may include a moisture sensor. “Moisture”, as used in this disclosure, is the presence of water, this may include vaporized water in air, condensation on the surfaces of objects, or concentrations of liquid water. Moisture may include humidity. “Humidity”, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. Moisture sensor may be psychrometer. Moisture sensor may be a hygrometer. Moisture sensor may be configured to act as or include a humidistat. A “humidistat”, for the purposes of this disclosure, is a humidity-triggered switch, often used to control another electronic device. Moisture sensor may use capacitance to measure relative humidity and include in itself, or as an external component, include a device to convert relative humidity measurements to absolute humidity measurements. “Capacitance”, for the purposes of this disclosure, is the ability of a system to store an electric charge, in this case the system is a parcel of air which may be near, adjacent to, or above a battery cell.

With continued reference to FIG. 1, at least a sensor 120 may include an electrical sensor. Electrical sensor may be configured to measure voltage across a component, electrical current through a component, and resistance of a component. Electrical sensors may include separate sensors to measure each of the previously disclosed electrical characteristics such as voltmeter, ammeter, and ohmmeter, respectively. Electrical sensor may be used to detect any number of electrical quantities associated with an aircraft power system or an electrical energy storage system such as, without limitation, plurality of battery packs 112. In some embodiments, electrical sensor may include a resistance sensor designed and configured to measure the resistance of at least an energy source such as, without limitation, at least one battery pack of plurality of battery packs 112. In some embodiments, at least a sensor 120 may be further configured to transmit electric signals to a data storage system to be save. In nonlimiting embodiments, battery electrical phenomena may be continuously measured and stored at an intermediary store location, and then permanently saved by data storage system at a later time. In some embodiments, at least a sensor 120 may include one or more electrical sensors of the same type used to measure the same electrical phenomena, as to provide redundancy, so in the event one of sensors fails, functionality of system 100 is maintained. In some embodiments, at least a sensor 120 may include different types of sensors measuring the same electric phenomena as to provide redundancy in case of sensor failure. In a nonlimiting example, one sensor continues to measure the battery voltage when another sensor stops working. Measuring electrical parameters may be consistent with any embodiment described in U.S. patent application Ser. No. 16/598,307 filed on Oct. 10, 2019 and entitled “METHODS AND SYSTEMS FOR ALTERING POWER DURING FLIGHT,” U.S. patent application Ser. No. 16/599,538 filed on Oct. 11, 2019 and entitled “SYSTEMS AND METHODS FOR IN-FLIGHT OPERATIONAL ASSESSMENT,” and U.S. patent application Ser. No. 16/590,496 filed on Oct. 2, 2019 and entitled “SYSTEMS AND METHODS FOR RESTRICTING POWER TO A LOAD TO PREVENT ENGAGING CIRCUIT PROTECTION DEVICE FOR AN AIRCRAFT,” all of which are incorporated herein by reference in their entirety.

With continued reference to FIG. 1, alternatively, or additionally, at least a sensor 120 may include a sensor or plurality thereof configured to detect voltage and direct the charging of individual the battery cells according to charge level; detection may be performed using any suitable component, set of components, and/or mechanism for direct or indirect measurement and/or detection of voltage levels, including without limitation comparators, analog to digital converters, any form of voltmeter, or the like. At least a sensor 120 and/or a control circuit incorporated therein and/or communicatively connected thereto may be configured to adjust charge to one or more the battery packs as a function of a charge level and/or a detected parameter. For instance, and without limitation, at least a sensor 120 may be configured to determine that a charge level of a battery module 116 (and battery cells within the battery module 116) is high based on a detected voltage level of that battery module 116 or portion of the battery pack 112. At least a sensor 120 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of the cell above a threshold level, detection of a voltage and/or resistance level above or below a threshold, or the like. At least a sensor 120 may include digital sensors, analog sensors, or a combination thereof. At least a sensor 120 may include digital-to-analog converters (DAC), analog-to-digital converters (ADC, A/D, A-to-D), a combination thereof, or other signal conditioning components used in transmission of a first plurality of battery pack data to a destination over wireless or wired connection.

With continued reference to FIG. 1, at least a sensor 120 may include thermocouples, thermistors, thermometers, passive infrared sensors, resistance temperature sensors (RTD's), semiconductor based integrated circuits (IC), a combination thereof or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within at least a sensor 120, may be measured in Fahrenheit (° F.), Celsius (° C.), Kelvin (° K), or another scale alone or in combination. The temperature measured by sensors may include electrical signals which are transmitted to their appropriate destination wirelessly or through a wired connection.

With continued reference to FIG. 1, at least a sensor 120 may include a sensor configured to detect gas that may be emitted during or after a cell failure. “Cell failure”, for the purposes of this disclosure, refers to a malfunction of a battery cell, which may be an electrochemical cell, that renders the cell inoperable for its designed function, namely providing electrical energy to at least a portion of an electric aircraft. Byproducts of cell failure may include gaseous discharge including oxygen, hydrogen, carbon dioxide, methane, carbon monoxide, a combination thereof, or another undisclosed gas, alone or in combination. Further the sensor configured to detect vent gas from electrochemical cells may include a gas detector. For the purposes of this disclosure, a “gas detector” is a device used to detect a gas is present in an area. Gas detectors, and more specifically, the gas sensor that may be used in at least a sensor 120, may be configured to detect combustible, flammable, toxic, oxygen depleted, a combination thereof, or another type of gas alone or in combination. The gas sensor that may be present in at least a sensor 120 may include a combustible gas, photoionization detectors, electrochemical gas sensors, ultrasonic sensors, metal-oxide-semiconductor (MOS) sensors, infrared imaging sensors, a combination thereof, or another undisclosed type of gas sensor alone or in combination. At least a sensor 120 may include sensors that are configured to detect non-gaseous byproducts of cell failure including, in non-limiting examples, liquid chemical leaks including aqueous alkaline solution, ionomer, molten phosphoric acid, liquid electrolytes with redox shuttle and ionomer, and salt water, among others. At least sensor 120 may include sensors that are configured to detect non-gaseous byproducts of cell failure including, in non-limiting examples, electrical anomalies as detected by any of the previously disclosed sensors or components.

With continued reference to FIG. 1, at least a sensor 120 may be configured to detect events where voltage nears an upper voltage threshold or lower voltage threshold. The upper voltage threshold may be stored in data storage system for comparison with an instant measurement taken by any combination of sensors present within at least a sensor 120. The upper voltage threshold may be calculated and calibrated based on factors relating to battery cell health, maintenance history, location within battery pack, designed application, and type, among others. At least a sensor 120 may measure voltage at an instant, over a period of time, or periodically. At least a sensor 120 may be configured to operate at any of these detection modes, switch between modes, or simultaneous measure in more than one mode. In a non-limiting example, at least a sensor 120 may detect a first event where voltage nears the lower voltage threshold. The lower voltage threshold may indicate power loss to or from an individual battery module (and/or battery cell) or portion of battery pack. At least a sensor 120 may detect a second event where voltage exceeds the upper voltage threshold. The upper voltage threshold may indicate power overdrive or overload of an individual battery module (and/or battery cell) or portion of battery pack. Events where voltage exceeds the upper and lower voltage threshold may indicate battery cell failure or electrical anomalies that could lead to potentially dangerous situations for aircraft and personnel that may be present in or near its operation.

With continued reference to FIG. 1, at least a sensor 120 may be communicatively connected to at least a pilot control, the manipulation of which, may constitute at least an aircraft command. At least a sensor 120 may include circuitry, computing devices, electronic components, or a combination thereof that translates an input datum into at least an electronic signal configured to be transmitted to another electronic component. At least a sensor 120 communicatively connected to at least a pilot control may include a sensor disposed on, near, around or within at least pilot control. At least a sensor may include an acoustic sensor including a microphone, piezoelectric sensor, diaphragm, or other acoustic sensors alone or in combination, for example and without limitation. At least a sensor may include a motion sensor. “Motion sensor”, for the purposes of this disclosure refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. At least a sensor 120 may include, torque sensor, gyroscope, accelerometer, torque sensor, magnetometer, inertial measurement unit (IMU), pressure sensor, force sensor, proximity sensor, displacement sensor, vibration sensor, among others. At least a sensor 120 may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor.

With continued reference to FIG. 1, processor 104 is configured to receive battery pack status data associated with each battery pack of plurality of battery packs 112. Processor 104 may be configured to receive battery pack status data 124 from at least a sensor 120. At least a sensor 120 is configured to detect battery pack status data 124 corresponding to plurality of battery packs. As used in this disclosure, “battery pack status data” is data representing an operating status of at a plurality of energy storage devices such as, without limitation, a plurality of battery packs 112, battery modules 116, battery cells, and/or the like thereof. In some embodiments, battery pack status data 124 may include battery pack status data 124 for each battery pack of plurality of battery packs 112. In some cases, battery pack status data 124 may include one or more parameters associated with the health, age, electrical characteristics, physical characteristics, calculations derived therefrom, or predictions associated with the battery packs 112 and/or at least a battery module 116 according to the detected parameters, among others. In a non-limiting embodiment, the battery pack datum may include at least an electrical parameter which may include, without limitation, voltage, current, impedance, resistance, and/or temperature. Current may be measured by using a sense resistor in series with the circuit and measuring the voltage drop across the resister, or any other suitable instrumentation and/or methods for detection and/or measurement of current. Each of resistance, current, and voltage may alternatively or additionally be calculated using one or more relations between impedance and/or resistance, voltage, and current, for instantaneous, steady-state, variable, periodic, or other functions of voltage, current, resistance, and/or impedance, including without limitation Ohm's law and various other functions relating impedance, resistance, voltage, and current regarding capacitance, inductance, and other circuit properties. In a non-limiting embodiment, battery pack status data 124 may include a first battery pack status datum corresponding to a first battery pack and a second battery pack status datum corresponding to a second battery pack detected by a first sensor and a second sensor respectively. First sensor may be disposed within first battery pack and second sensor may be disposed within second battery pack. In another non-limiting example, battery pack status data 124 may include one or more battery pack data, wherein the battery pack datum may be consistent with any battery pack datum disclosed in U.S. patent application Ser. No. 17/524,265. Additionally, or alternatively, battery pack status data 124 may include one or more elements of data corresponding to failure of battery pack, at least a battery module 116, battery cell, or another portion of plurality of battery packs 112. Battery pack status data 124 may include location, type, severity, percentage, or combination of those parameters, among others, of plurality of battery packs 112; for instance, without limitation, battery pack status data 124 may include a percentage of usable battery modules 116 that is defective, operational, catastrophically damaged, or overheated for each battery pack of plurality of battery packs 112 consistent with the entirety of this disclosure. Battery pack status data 124 may include more than one signal corresponding to the type of sensor from which is was detected. In a non-limiting example, battery pack status data 124 may include a status datum, wherein the status datum may be consistent with any status datum disclosed in U.S. patent application Ser. No. 17/241,396. Battery pack status data may be transmitted by one or more elements of system 100 through a wired or wireless connection consistent with this disclosure to processor 104.

With continued reference to FIG. 1, in some embodiments, receiving battery pack status data 124 may include receiving battery pack status data 124 from a battery pack model associated with battery pack. As used in this disclosure, a “battery pack model” is a conceptual representation of plurality of battery packs 112. In some embodiments, battery pack model may include a plurality of conceptual representation of each battery pack of plurality of battery packs 112. In some embodiments, battery pack model may not be concrete, thus, battery pack model may include a virtual battery pack model, a hypothetical battery pack, and the like thereof. In some embodiments, battery pack model may include statistical information about the battery pack; for instance, and without limitation, battery pack model may include battery capacity, battery internal loss, any battery pack status data described in this disclosure, and/or the like thereof. In some embodiments, battery pack status data 124 may be distinct within battery pack model. In a non-limiting example, battery pack model may specify battery pack status data 124 received from a user such as electrical professional. Battery pack status data 124 may be predefined by the user. In some embodiments, battery pack status data 124 may be obscure within battery pack model. In this cases, battery pack status data 124 may be derived from or by the battery pack model. In a non-limiting example, battery pack model may be configured to calculate and/or determine battery pack status data 124 for each battery pack as a function of the battery pack model; for instance, and without limitation, battery pack model may include a plurality of parameters related to plurality of battery packs 112 such as, without limitation, voltage of each battery pack, current of each battery pack, usage time of each battery pack, and the like. Battery pack model may be configured to calculate battery pack capacity for each battery pack of plurality of battery packs 112. In some cases, processor 104 may be configured to receive a plurality of parameters related to plurality of battery packs 112 specified in battery pack model as described above, and determine battery pack status data 124 based on these parameters.

With continued reference to FIG. 1, in some embodiments, battery pack status data 124 may include battery pack health data 128 of plurality of battery packs 112. Battery pack status data 124 may include battery pack health data 128 for each battery pack of plurality of battery packs 112. As used in this disclosure, a “battery pack health data” is data that corresponds to the health of at least a portion of a battery pack 112 or at least a battery module 116 within the battery pack 112. In some embodiments, battery pack health data may include one or more elements of data related to the sate of health (SoH) of plurality of battery packs 112 or battery modules 116. “State of health,” for the purposes of this disclosure, is a figure of merit of the condition of a battery pack (or battery module, or battery cell) compared to its ideal conditions. The units of SoH are percent points (100%=the battery's conditions match the battery's specifications). Typically, a battery's SoH will be 100% at the time of manufacture and will decrease over time and use. However, a battery's performance at the time of manufacture may not meet its specifications, in which case its initial SoH will be less than 100%. In exemplary embodiments, one or more elements of system 100 including but not limited to processor 104 may evaluate state of health of the portion of battery corresponding to battery pack health data 128. Battery pack health data 128 may be compared to a threshold battery pack health data corresponding to the parameter detected to generate said battery pack health data 128. In some embodiments, battery pack health data 128 may be utilized to determine, by processor 104, the suitability of battery packs 112 to a given application, such as aircraft flight envelope, mission, cargo capacity, speed, maneuvers, or the like. Additionally, or alternatively, battery pack health data 128 may include a useful life estimate corresponding to plurality of battery packs 112 or battery modules 116. In some cases, battery pack health data 128 may include a useful life estimate for each battery pack (or battery module) of plurality of battery packs 112. For the purposes of this disclosure, a “useful life estimate” is one or more elements of data indicating a remaining usability of one or more elements of an energy storage device such as, without limitation, plurality of battery packs 112 or battery modules 116, wherein the usability is a function of whether the one or more energy storage elements may be used in performing their designed functions. Useful life estimate may include one or more elements of data related to the remaining use of battery pack 112 or battery module 116. Useful life estimate may include a time limit, usage limit, amperage per time parameter, electric parameter, internal resistance, impedance, conductance, capacity, voltage, self-discharge, ability to accept a charge, number of charge-discharge cycles, age of battery, temperature of battery during previous uses, current or future temperature limitations, total energy charged, total energy discharge, or predictions of failures corresponding to plurality of battery packs 112. Processor 104 may select data collected from one or more sensors described herein or one or more elements of data input to system 100 from which processor 104 may retrieve. Processor 104 may be communicatively connected to one or more databases, datastores, lists, matrices, and/or groups that represent and organize data associated with plurality of battery packs 112. Additionally, or alternatively, battery pack status data 124 may include battery pack charge data 132. Battery pack status data 124 may include battery pack charge data 132 for each battery pack of plurality of battery packs 112. As used in this disclosure, a “battery pack charge data” is data related to state of charge (SoC) of battery pack 112. For the purposes of this disclosure, “state of charge” is the level of charge of an electric battery relative to its capacity. The units of SoC may be percentage points (0%=empty; 100%=full). An alternative form of the same measure is the depth of discharge (DoD), the inverse of SoC (100%=empty; 0%=full). SoC is normally used when discussing the current state of a battery in use, while DoD may be often seen when discussing the lifetime of the battery after repeated use. Battery pack charge data 132 may be one or more elements of data related to the charge of a battery configured for use in an electric aircraft. In an EVTOL, for example, SoC for the plurality of battery pack 112 may be the equivalent of a fuel gauge in a gasoline powered vehicle. Battery pack charge data 132 may be calculated, adjusted, searched for in a table, retrieved from a database based on one or more detected parameters, or directly detected, among others.

With continued reference to FIG. 1, in some embodiments, battery pack status data 124 may include internal state data 136 and an external state data 140 for plurality of battery packs. Battery pack status data 124 may include internal state data 136 and an external state data 140 for each battery pack of plurality of battery packs 112. As used in this disclosure, an “internal state data” is data usable to determine an internal state of plurality of battery packs 112. In an embodiment, internal state data 136 may include a mechanical degradation of battery pack 112, such as battery swell. In an embodiment, internal state data 136 may include an internal resistance and/or impedance of the battery. In one embodiment, internal state data may further include other information captured by at least a sensor 120 related to battery pack 112 described above, such as, without limitation, temperature. As used in this disclosure, “external state data” refers to conditions outside of the battery pack, such as increasing vibration. In a non-limiting example, external state data may include a degree of vibration detected by a motion sensor of at least a sensor 120 described above, wherein the at least a sensor 120 may be disposed externally near the battery pack 112. In a further non-limiting example, internal state data and external state data may be consistent with any internal state datum and external state datum disclosed in U.S. Pat. No. 11,443,569, filed on Oct. 30, 2021, and titled, “SYSTEMS AND METHODS FOR BATTERY MANAGEMENT FOR A VEHICLE”, which is incorporated herein in its entirety by reference.

With continued reference to FIG. 1, battery pack status data 124 may include a battery pack degradation prediction 144. Battery pack status data 124 may include a battery pack degradation prediction 144 for each battery pack of plurality of battery packs. Battery pack degradation prediction 144 may be determined by processor 104 subsequent to receiving battery pack status data 124 as a function of received battery pack status data 124 from at least a sensor 120. As used in this disclosure, a “battery pack degradation prediction” is a model, a simulation, or otherwise an element of data representing the degradation of a battery pack 112 or at least a battery module 116. For example, and without limitation, battery pack degradation prediction 144 may include an element of data representing a potential degraded state of battery pack 112. For example, and without limitation, battery degradation prediction 144 may include a model such as a battery pack degradation model. A “battery pack degradation model,” for the purpose of this disclosure, is any virtual representation and/or battery pack model representing a predictive battery pack model describing a future degraded state of battery pack 112. In a non-limiting embodiment, the battery degradation pack model may include a graphical representation depicting the state of charge of battery pack 112 as a function of time. For instance, and without limitation, the battery pack degradation model may be consistent with FIG. 7, a graph showing the state of charge of an energy source as a function of time, in U.S. patent application Ser. No. 16/599,538, filed on Oct. 11, 2019, and titled “SYSTEMS AND METHODS FOR IN-FLIGHT OPERATIONAL ASSESSMENT,” which is incorporated in its entirety herein. In some embodiments, processor 104 may be configured to generate one or more battery pack degradation predictions 144 associated with plurality of battery packs 112 using a battery pack degradation estimation. As used in this disclosure, “battery pack degradation estimation” is any element of data describing a value or rate describing the degrading capabilities of a battery pack 112. In a non-limiting embodiment, processor 104 may calculate battery pack degradation estimation continuously and/or dynamically throughout a duration of an operation of electric aircraft. In other embodiments, processor 104 may be configured to generate one or more battery pack degradation predictions 144 associate to plurality of battery packs 112 using a machine-learning model which described in more detail in U.S. patent application Ser. No. 17/524,265. Battery pack degradation prediction, battery pack degradation estimation, and any method used for generating battery pack degradation prediction may be consistent with any battery degradation prediction, battery degradation estimation, and any method used for generating battery degradation prediction disclosed in U.S. patent application Ser. No. 17/524,265.

With continued reference to FIG. 1, processor is configured to generate a battery pack diagnostic datum 148 for each battery pack of plurality of battery packs 112 as a function of battery pack status data 124 of each battery pack of plurality of battery packs. As used in this disclosure, a “battery pack diagnostic datum” is an element of data indicating the use of one or more battery packs of plurality of battery packs 112. In some embodiments, battery pack diagnostic datum 148 may include an indicator indicating SoH of one or more battery packs of plurality of battery packs 112. In a non-limiting example, battery pack diagnostic datum 148 may include an indicator indicating such as, without limitation, weak battery pack, moderate battery pack, healthy battery pack, and the like thereof. Such indicator may be determined as a function of the comparison of battery pack status data 124 and battery pack status threshold; for instance, and without limitation, indicator indicating weak battery pack may be determined when battery pack resistance exceeds a threshold battery pack resistance, while another indicator indicating moderate battery pack and healthy battery pack may be determined when battery pack resistance is below the threshold battery pack resistance, depending on the magnitude of the degree below threshold battery pack resistance. Threshold battery pack resistance may be calculated and determined by battery pack status model 150 described below. In some embodiments, battery pack diagnostic datum 148 may include an efficiency factor 152. As used in this disclosure, an “efficiency factor” is an indicator indicating the efficiency of one or more battery packs within plurality of battery packs 112. As used in this disclosure, “battery pack efficiency” refers to the ratio of electric energy input to electric energy output of the battery pack. In some cases, efficiency factor 152 may include factors that affecting battery pack efficiency, such as, without limitation, charge current, temperature, SoC, internal loss, internal resistance of plurality of battery packs 112 and the like thereof. In a non-limitation, efficiency factor 152 within battery pack diagnostic datum 148 may include an indicator indicating a degree of limitation of weak battery pack to healthy battery pack; for instance, plurality of battery packs 112 may be charged using a high current busbar and integral electrical connections, wherein charging may be balanced throughout plurality of the battery packs 112 (battery modules or battery cells) by directing electric energy through one or more balance resistors by dissipating current through one or more resistors as heat. In this manner, plurality of battery packs may be charged evenly. However, weak battery packs may require more voltage than healthy battery packs with a greater amount of electric energy, thus limit battery pack efficiency of healthy battery packs. In other cases, without limitation, efficiency factor 152 may include cost efficiency of battery packs such as, without limitation, maintenance cost, production cost, and the like thereof. In other embodiments, battery pack diagnostic datum 148 may include a safety factor 156. As used in this disclosure, a “safety factor” is an indicator indicating safety of one or more battery packs within plurality of battery packs 112. In a non-limiting example, safety factor 156 within battery pack diagnostic datum 148 may include one or more element of data representing potential safety outcome of one or more battery packs; for instance, without limitation, safety factor 156 of a weak battery pack may include a possibility of electrical burns within plurality of battery packs 112 caused by internal short circuit due to the weak battery pack overdriving potential in other healthy battery packs through high current busbar. In another non-limiting example, safety factor 156 within battery pack diagnostic datum 148 may include a truth value representing occurrence of an event related to plurality of battery packs; for instance, safety factor 156 may include a Boolean value indicating whether an event related to plurality of battery packs 112 will occur, wherein the event may include, without limitation, battery pack overload caused by weak battery pack acquiring more electric energy from high current bus bar than high current bus bar can handle. Persons skilled in the art, upon reviewing the entirety of this disclosure, will be aware of the various efficiency factors and safety factors within battery pack diagnostic datum consistently with this disclosure.

With continued reference to FIG. 1, generating battery pack diagnostic datum may include modeling a battery pack status model 150 as a function of battery pack status data 124. As used in this disclosure, “modeling” means translating and/or inputting one or more objects such as, without limitation, battery pack status data of plurality of battery packs 112 into a computational model, wherein the computational model is simply one or more mathematical equations. As used in this disclosure, a “battery pack status model” is a computational model that represent an expected state of plurality of battery packs 112. In some embodiments, battery pack status model may be configured to model a battery pack capacity as a function of battery pack status data 124. As used in this disclosure, a “battery pack capacity” is a quantitative measurement of the total amount of electric power generated due to electrochemical reactions in the battery pack. Battery pack capacity may be expressed in ampere hours (Ah). In a non-limiting example, modeling battery pack capacity may include calculating an expected battery pack capacity as a function of battery pack status data 124 such as, without limitation, total number of battery cells, size of battery cell, and the like within at least one battery module 116 of battery pack 112. In some embodiments, battery pack status model 150 may be configured to model a battery pack internal loss as a function of battery pack status data 124. As used in this disclosure, a “battery pack internal loss” is a quantitative measurement representing an amount of stored charge of the battery pack reduced due to reduced internal electrochemical reactions without any connection between electrodes, external circuit, or other electric energy storage device. In some cases, modeling battery pack internal loss may include modeling self-discharge of plurality of battery packs as a function of battery pack status data 124. In a non-limiting example, battery pack status data 124 such as, without limitation, battery pack SoC (i.e., battery pack charge data), charging current, ambient temperature, and the like may be used to calculate how fast self-discharge in each battery pack of plurality of battery packs. In some embodiments, one or more measurement returned by battery pack status model 150 may be used as input to battery pack status model 150 to simulate other measurements related to plurality of battery packs 112. In a non-limiting example, battery pack status model 150 may be configured to model a battery pack resistance as a function of battery capacity, wherein the battery pack resistance is a quantitative measurement of resistance to current flow within battery pack 112; for instance, without limitation, a large battery pack resistance may be modeled as a function of a given low battery pack capacity, wherein the given low battery pack capacity may be modeled by battery pack status model 150 previously as a function of battery pack status data 124 containing a large battery age. Additionally, or alternatively, generating battery pack diagnostic datum 148 may include generating a battery pack diagnostic datum 148 for each battery pack of plurality of battery packs as a function of the battery pack status model 150; for instance, and without limitation, processor 104 may compare battery pack status data 124 of each battery pack of plurality of battery packs 112 to a modeled battery pack related measurement such as, without limitation, battery pack capacity, battery pack internal loss, battery pack resistance, and the like, and generate a battery pack diagnostic datum 148 for each battery pack of plurality of battery packs 112. Persons skilled in the art, upon reviewing the entirety of this disclosure, will be aware of the various measurements related to plurality of battery packs that battery pack status model consistently with this disclosure may be capable of modeling.

With continued reference to FIG. 1, in some embodiments, processor 104 may use a machine learning module, such as battery pack diagnostic module 160, to implement one or more algorithms or generate one or more machine-learning models, such as battery pack diagnostic machine-learning model 164, to determine battery pack diagnostic datum 148. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories/values of data elements. Exemplary inputs and outputs may come from data storage device, such as database, or be provided by a user. In other embodiments, a machine-learning module may obtain a training set by querying a communicatively connected database that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories or values of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. Battery pack diagnostic module 160 may be used to generate battery pack diagnostic machine-learning model and/or any other machine learning model, such as optimal battery pack combination machine-learning model 176, and the like described below, using training data. Battery pack diagnostic machine-learning model 164 may be trained by correlated inputs and outputs of training data. Training data may be data sets that have already been converted from raw data whether manually, by machine, or any other method. Training data may include previous outputs such that Battery pack diagnostic machine-learning model 164 iteratively produces outputs. Battery pack diagnostic machine-learning model 164 using a machine-learning process may output converted data based on input of training data. In an embodiment, generating battery pack diagnostic datum 148 may include generating battery pack diagnostic datum 148 based on battery pack status data 124 using a machine learning model, such as battery pack diagnostic machine-learning model 164 generated by battery pack diagnostic module 160. Battery pack diagnostic machine-learning model 164 may be trained by training data, discussed in further detail below, such as battery pack training data. Battery pack training data may be stored in data storage device such as a database.

With continued reference to FIG. 1, generating battery pack diagnostic datum 148 based on battery pack status data 124 using a machine-learning model may include receiving battery pack training data. In an embodiment, battery pack training data may include a plurality of battery pack status data 124 that are each correlated to a battery pack diagnostic datum 148. For example, battery pack training data may be used to show battery pack status data 124 may indicate one or more efficiency factor 152 and/or safety factor 156 of plurality of battery packs 112. generating battery pack diagnostic datum 148 using a machine-learning model may further include training a battery pack diagnostic machine-learning model 164 as a function of battery pack training data. Further, generating battery pack diagnostic datum 148 using a machine-learning model may also include generating battery pack diagnostic datum 148 using trained battery pack diagnostic machine-learning model 164.

With continued reference to FIG. 1, processor 104 is configured to determine a suitability 168 of the plurality of battery packs as a function of each battery pack diagnostic datum 148 for each battery pack of the plurality of battery packs 112. As used in this disclosure, “suitability” refers to a quality of plurality of battery packs 112 being right or appropriate for electric aircraft. In some cases, suitability 168 of plurality of battery packs 112 may include a numeric representation; for instance, and without limitation, a score, a rank, a value, a measurement, or the like. In some embodiments, plurality of battery packs 112 may be right or appropriate for electric aircraft if plurality of battery packs 112 provide enough electric power at a specified voltage. In a non-limiting example, processor 104 may receive a plurality of battery pack status data 124 containing a current reading, detected by at least a sensor 120. Generating battery pack diagnostic datum 148 may include comparing the current reading to a minimum battery pack current required by electric propulsor of electric aircraft. Suitability 168 of the plurality of battery packs 112 may be determined as a function of the comparison; for instance, without limitation, plurality of battery packs 112 may output stored electric energy at a rate, detected by at least a sensor 120, that exceed minimum battery pack current. Plurality of battery packs 112 that is not capable of outputting electric energy at such rate may not be right or appropriate for electric aircraft. In some embodiments, plurality of battery packs 112 may be right or appropriate for electric aircraft if plurality of battery packs 112 operate below a threshold battery temperature. In a non-limiting example, processor 104 may receive battery pack status data 124 containing a plurality of temperature readings of plurality of battery packs 112 from at least a sensor 120, wherein each temperature reading may correspond to a battery pack of plurality of battery packs. Processor 104 may generate a battery pack diagnostic datum 148 using battery pack status model, wherein the battery pack diagnostic datum 148 may include a calculated average temperature reading of plurality of battery packs 112. Processor 104 may determine a suitability 168 by comparing calculated average temperature reading of plurality of battery packs 112 to a threshold battery pack temperature. Plurality of battery packs 112 may be in an overheating condition when average temperature reading exceed threshold battery pack temperature. Overheating condition may present danger to other components of electric aircraft and/or electric aircraft operations. Additionally, or alternatively, suitability 168 of the plurality of battery packs 112 may be determined as a function of each efficiency factor 152 within each battery pack diagnostic datum 148 for each battery pack of plurality of battery packs 112. In a non-limiting example, plurality of battery packs may include one or more battery packs with significantly lower efficient factors compared to other efficient factors for other battery packs of plurality of battery packs. One or more battery packs with significantly lower efficient factors may over drive potentials from other battery packs of plurality of battery packs to meet the needs of electric aircraft. Such plurality of battery packs may not be right or appropriate for electric aircraft due to a low battery efficiency. Further, suitability 168 of the plurality of battery packs 112 may be determined as a function of each safety factor 156 within each battery pack diagnostic datum 148 for each battery pack of plurality of battery packs 112. In a non-limiting example, plurality of battery packs may include one or more battery packs with higher risks, identified by safety factors, compared to other battery packs of plurality of battery packs 112. Risk may include, without limitation, battery pack compatibility, internal short circuit, overheating, overdrive, overload, and the like thereof. Such plurality of battery packs may not be right or appropriate for electric aircraft due to a high safety hazards.

With continued reference to FIG. 1, processor 104 may be further configured to determine an optimal battery pack combination 172 as a function of battery pack diagnostic datum 148. As used in this disclosure, a “battery pack combination” is a combination of plurality of battery packs 112 used by electric aircraft for any functionalities of electric aircraft that requires electric energy. As used in this disclosure, an “optimal battery pack combination” is a combination of plurality of battery packs 112 with a maximum battery pack efficiency or safety. In some embodiments, optimal battery pack combination 172 may include a combination of plurality of battery packs 112 with different battery pack status data. For example, without limitation, optimal battery pack combination 172 may include a combination of plurality of battery packs 112 with different charge level. For example, without limitation, optimal battery pack combination 172 may include a combination of plurality of battery packs 112 containing one or more degraded battery packs. For example, without limitation, optimal battery pack combination 172 may include a combination of a plurality of battery packs 112, wherein the plurality of battery packs 112 may include one or more weak battery packs, one or more moderate battery packs, and/or one or more healthy battery packs. In some embodiments, optimal battery pack combination 172 may be determined as a function of efficiency factor 152 and safety factor 156. In a non-limiting example, determining optimal battery pack combination 172 may include selecting at least two battery packs that maximize the efficiency factor 152 and minimize the safety factor 156 of the at least two battery packs. At least two battery packs may include a first battery pack (i.e., healthy battery pack) with a first voltage and a second battery pack (weak battery pack) with a second voltage, wherein the first voltage is greater than the second voltage. However, such combination may not be optimal if the first voltage is significantly greater than the second voltage since second battery pack may slowly discharge first battery pack util the voltage equalizes. Additionally, or determining optimal battery pack combination 172 may include identifying at least a battery pack of the plurality of battery packs 112 for replacement as a function of optimal battery pack combination 172.

With continued reference to FIG. 1, in some embodiments, determining optimal battery pack combination 172 may include classifying battery pack diagnostic datum to optimal battery pack combination 172 for electric aircraft using a machine learning model, such as optimal battery pack combination machine-learning model 176 generated by battery pack diagnostic module 160. Optimal battery pack combination machine-learning model 176 may be trained by optimal battery pack combination training data, wherein the optimal battery pack combination training data may include a plurality of battery pack diagnostic datum as input correlated to a plurality of optimal battery pack combinations as output. Optimal battery pack combination training data may be stored in data storage device, such as database described above. For example, optimal battery pack combination training data may be used to show battery pack diagnostic data may indicate a particular optimal battery pack combination 172 for electric aircraft to perform its functions. Generating optimal battery pack combination 172 using a machine learning model may further include training the optimal battery pack combination machine-learning model 176 as a function of optimal battery pack combination training data. Further, generating optimal battery pack combination 172 using a machine learning model may also include generating at least one optimal battery pack combination 172 using trained optimal battery pack combination machine-learning model 176.

With continued reference to FIG. 1, additionally, or alternatively, optimal battery pack combination machine-learning model 176 may include a classifier. A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Processor 104 and/or another device may generate a classifier using a classification algorithm, defined as a process whereby a processor 104 derives a classifier from training data, such as optimal battery pack combination training data. Classification may be performed using, without limitation, linear classifiers such as without limitation logistic regression and/or naïve Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, processor 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(AB) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, processor 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, in some embodiments, processor 104 may determine optimal battery pack combination 172 using a using a lookup table. A “lookup table,” for the purposes of this disclosure, is an array of data that maps input values to output values. A lookup table may be used to replace a runtime computation with an array indexing operation. In another non limiting example, a state score lookup table may be able to correlate a plurality of battery pack diagnostic datum for a plurality of battery packs 112 to an optimal battery pack combinations. Processor 104 may be configured to “lookup” plurality of battery pack diagnostic datum in order to find a corresponding optimal battery pack combination 172.

With continued reference to FIG. 1, in some embodiments, determining optimal battery pack combination 172 may include generating a flight simulation 180 as a function of optimal battery pack combination 172. As used in this disclosure a “flight simulation” is an imitation of aircraft and/or flight of an aircraft. In some embodiments, flight simulation may simulate the discharge and/or usage of a battery pack 112 during flight, as opposed to simulating the flight of an aircraft itself. For example, and without limitation, flight simulation may denote at least a flight element of an electric aircraft, wherein a flight element is an element of datum denoting a relative status of aircraft. In an embodiment, and without limitation, a flight element may denote one or more torques, thrusts, airspeed velocities, forces, altitudes, groundspeed velocities, directions during flight, directions facing, forces, orientations, and the like thereof. In an embodiment, flight element may denote one or more battery pack combinations. Flight simulation 180 may include an electric aircraft model. In an embodiment, and without limitation, electric aircraft model may be configured to include operational data of a flight component for a plurality of simulated conditions. As used in this disclosure “operational data” is information denoting one or more operational functions of a flight component. For example, and without limitation, operational data may denote one or more rotational speeds, torques, forces, rpms, and the like thereof. For another example, and without limitation, operational data may denote one or more battery pack combinations. In an embodiment, and without limitation, electric aircraft model may produce a simulation denoting one or more adjustments to electric aircraft. In a non-limiting example, electric aircraft model may produce a simulation denoting one or more modifications to plurality of battery packs as a function of optimal battery pack combination 172. Electric aircraft model may be configured to simulate a performance of electric aircraft as a function of a mission profile. Simulating performance of electric aircraft may include simulating mission profile of an electric aircraft. As used in this disclosure, a “mission profile” is a sequence of operations of electric aircraft. The operation may include any step in a flight sequence. In some embodiments, mission profile may include an initialization operation for preparing a flight of an electric aircraft. In some embodiments, mission profile may include a takeoff operation. The takeoff operation may include procedures and steps that my correlate to an initial transition from a resting position to a hovering position. In some embodiments, mission profile may include a cruising operation. The cruising operation may include procedures and that may correlate to transitioning an electric aircraft from a takeoff position to a cruising position. In some embodiments, mission profile may include a landing operation. The landing operation may include procedures and steps that may correlate with landing an electric aircraft. In some embodiments, simulating performance through flight simulation may use a virtual reality. In some embodiments, simulating performance through flight simulation may use an augmented reality. Electric aircraft model may include a power system. The power system may include an electrical system that may include a plurality of battery packs 112. In some embodiments, power system may include a plurality of battery packs 112 in optimal battery pack combination 172. In some embodiments, electric aircraft model may include a flight system. The flight system may include one or more propulsors. In some embodiments, electric aircraft model may further include model parameters such as, without limitation, weather, altitude, location, wind speed, aircraft weight, aircraft dimensions, fuel supply, aircraft health, propulsion systems, power systems, cargo status, and/or other parameters, alone or in combination. Processor 104 may be configured to apply model parameters to electric aircraft model. In some embodiments, model parameters may include battery pack status data 124, battery pack diagnostic datum 148, suitability 168 of plurality of battery packs of electric aircraft model. In some embodiments, electric aircraft model may include a high voltage simulation. In some embodiments, electric aircraft may include a low voltage simulation. Flight simulation and electric aircraft model described here may be consistent with any simulation and electric aircraft model disclosed in U.S. patent application Ser. No. 17/948,344, filed on Sep. 20, 2022, and entitled “SYSTEMS AND METHODS FOR RESTRICTING POWER TO A LOAD TO PREVENT ENGAGING CIRCUIT PROTECTION DEVICE FOR AN AIRCRAFT,” which are incorporated herein by reference in its entirety.

With continued reference to FIG. 1, in some embodiments, processor 104 may be configured to determine a performance of electric aircraft or electric aircraft model. A “performance” as defined in this disclosure is the difference of an action relative to a desired goal or outcome of the action. Performance may be determined from a plurality of factors. Performance may be determined based on pilot command. In some embodiments, performance may be determined relative to model parameters such as, without limitation, optimal battery pack combination 172. In some embodiments performance may be determined based on a time score. In some embodiments, performance may be determined based on fuel efficiency (or battery efficiency). In some embodiments, performance may be determined based on a landing of electric aircraft model described above. Processor 104 may be configured to output a flight simulation feedback as a function of the performance of the electric aircraft. In a non-limiting example, processor 104 may transform performance into a flight simulation feedback. As used in this disclosure, a “flight simulation feedback” is data that relays performance simulated through flight simulation to an end user. In some embodiments, flight simulation feedback may include a user score. In some embodiments, flight simulation feedback may include a breakdown of areas of improvement based on performance. In some cases, area of improvement may include battery efficiency such as, without limitation, battery pack combination. In other cases, area of improvement may include electric aircraft operations, electric aircraft health and/or other metrics. In a non-limiting example, flight simulation feedback may be configured to display a battery performance metric. The battery performance metric may include, but is not limited to, battery pack status data 124 of optimal battery pack combination 172 such as, without limitation, battery charge, battery health, battery temperature, and/or battery usage. Generating flight simulation 180 may further include determining, by processor 104, optimal battery pack combination as a function of flight simulation feedback; for instance, without limitation, performance and flight simulation feedback may be consistent with any performance and feedback described in U.S. patent application Ser. No. 17/948,344.

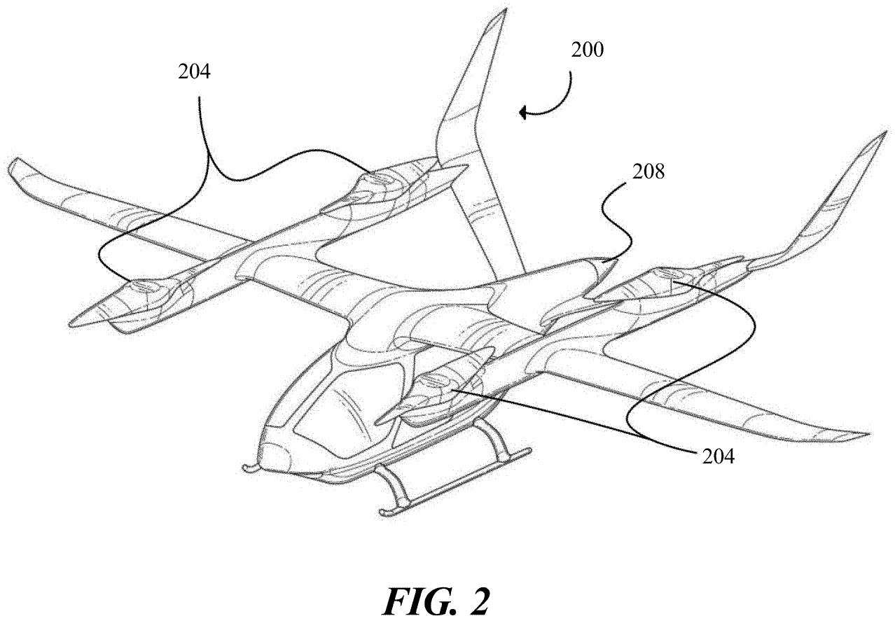

Now referring to FIG. 2, an exemplary embodiment of an eVTOL 200 is illustrated. eVTOL 200 may include a fuselage 204. As used in this disclosure a “fuselage” is the main body of an aircraft, or in other words, the entirety of the aircraft except for the cockpit, nose, wings, empennage, nacelles, any and all control surfaces, and generally contains an aircraft's payload. Fuselage 204 may comprise structural elements that physically support the shape and structure of an aircraft. Structural elements may take a plurality of forms, alone or in combination with other types. Structural elements may vary depending on the construction type of aircraft and specifically, the fuselage. Fuselage 204 may comprise a truss structure. A truss structure is often used with a lightweight aircraft and comprises welded steel tube trusses. A truss, as used herein, is an assembly of beams that create a rigid structure, often in combinations of triangles to create three-dimensional shapes. A truss structure may alternatively comprise wood construction in place of steel tubes, or a combination thereof. In embodiments, structural elements may comprise steel tubes and/or wood beams. In an embodiment, and without limitation, structural elements may include an aircraft skin. Aircraft skin may be layered over the body shape constructed by trusses. Aircraft skin may comprise a plurality of materials such as plywood sheets, aluminum, fiberglass, and/or carbon fiber, the latter of which will be addressed in greater detail later in this paper.

In embodiments, fuselage 204 may comprise geodesic construction. Geodesic structural elements may include stringers wound about formers (which may be alternatively called station frames) in opposing spiral directions. A stringer, as used herein, is a general structural element that comprises a long, thin, and rigid strip of metal or wood that is mechanically coupled to and spans the distance from, station frame to station frame to create an internal skeleton on which to mechanically couple aircraft skin. A former (or station frame) can include a rigid structural element that is disposed along the length of the interior of fuselage 204 orthogonal to the longitudinal (nose to tail) axis of the aircraft and forms the general shape of fuselage 204. A former may comprise differing cross-sectional shapes at differing locations along fuselage 204, as the former is the structural element that informs the overall shape of a fuselage 204 curvature. In embodiments, aircraft skin can be anchored to formers and strings such that the outer mold line of the volume encapsulated by the formers and stringers comprises the same shape as eVTOL 200 when installed. In other words, former(s) may form a fuselage's ribs, and the stringers may form the interstitials between such ribs. The spiral orientation of stringers about formers provides uniform robustness at any point on an aircraft fuselage such that if a portion sustains damage, another portion may remain largely unaffected. Aircraft skin would be mechanically coupled to underlying stringers and formers and may interact with a fluid, such as air, to generate lift and perform maneuvers.

In an embodiment, and still referring to FIG. 2, fuselage 204 may comprise monocoque construction. Monocoque construction may include a primary structure that forms a shell (or skin in an aircraft's case) and supports physical loads. Monocoque fuselages are fuselages in which the aircraft skin or shell is also the primary structure. In monocoque construction aircraft skin would support tensile and compressive loads within itself and true monocoque aircraft can be further characterized by the absence of internal structural elements. Aircraft skin in this construction method is rigid and can sustain its shape with no structural assistance form underlying skeleton-like elements. Monocoque fuselage may comprise aircraft skin made from plywood layered in varying grain directions, epoxy-impregnated fiberglass, carbon fiber, or any combination thereof.

According to embodiments, fuselage 204 may include a semi-monocoque construction. Semi-monocoque construction, as used herein, is a partial monocoque construction, wherein a monocoque construction is describe above detail. In semi-monocoque construction, fuselage 204 may derive some structural support from stressed aircraft skin and some structural support from underlying frame structure made of structural elements. Formers or station frames can be seen running transverse to the long axis of fuselage 204 with circular cutouts which are generally used in real-world manufacturing for weight savings and for the routing of electrical harnesses and other modern on-board systems. In a semi-monocoque construction, stringers are the thin, long strips of material that run parallel to fuselage's long axis. Stringers may be mechanically coupled to formers permanently, such as with rivets. Aircraft skin may be mechanically coupled to stringers and formers permanently, such as by rivets as well. A person of ordinary skill in the art will appreciate that there are numerous methods for mechanical fastening of the aforementioned components like crews, nails, dowels, pins, anchors, adhesives like glue or epoxy, or bolts and nuts, to name a few. A subset of fuselage under the umbrella of semi-monocoque construction is unibody vehicles. Unibody, which is short for “unitized body” or alternatively “unitary construction”, vehicles are characterized by a construction in which the body, floor plan, and chassis form a single structure. In the aircraft world, unibody would comprise the internal structural elements like formers and stringers are constructed in one piece, integral to the aircraft skin as well as any floor construction like a deck.

Still referring to FIG. 2, stringers and formers which account for the bulk of any aircraft structure excluding monocoque construction can be arranged in a plurality of orientations depending on aircraft operation and materials. Stringers may be arranged to carry axial (tensile or compressive), shear, bending or torsion forces throughout their overall structure. Due to their coupling to aircraft skin, aerodynamic forces exerted on aircraft skin will be transferred to stringers. The location of said stringers greatly informs the type of forces and loads applied to each and every stringer, all of which may be handled by material selection, cross-sectional area, and mechanical coupling methods of each member. The same assessment may be made for formers. In general, formers are significantly larger in cross-sectional area and thickness, depending on location, than stringers. Both stringers and formers may comprise aluminum, aluminum alloys, graphite epoxy composite, steel alloys, titanium, or an undisclosed material alone or in combination.

In an embodiment, and still referring to FIG. 2, stressed skin, when used in semi-monocoque construction is the concept where the skin of an aircraft bears partial, yet significant, load in the overall structural hierarchy. In other words, the internal structure, whether it be a frame of welded tubes, formers and stringers, or some combination, is not sufficiently strong enough by design to bear all loads. The concept of stressed skin is applied in monocoque and semi-monocoque construction methods of fuselage 204. Monocoque comprises only structural skin, and in that sense, aircraft skin undergoes stress by applied aerodynamic fluids imparted by the fluid. Stress as used in continuum mechanics can be described in pound-force per square inch (lbf/in²) or Pascals (Pa). In semi-monocoque construction stressed skin bears part of the aerodynamic loads and additionally imparts force on the underlying structure of stringers and formers.

Still referring to FIG. 2, it should be noted that an illustrative embodiment is presented only, and this disclosure in no way limits the form or construction of eVTOL 200. In embodiments, fuselage 204 may be configurable based on the needs of eVTOL 200 per specific mission or objective. The general arrangement of components, structural elements, and hardware associated with storing and/or moving a payload may be added or removed from fuselage 204 as needed, whether it is stowed manually, automatedly, or removed by personnel altogether. Fuselage 204 may be configurable for a plurality of storage options. Bulkheads and dividers may be installed and uninstalled as needed, as well as longitudinal dividers where necessary. Bulkheads and dividers may be installed using integrated slots and hooks, tabs, boss and channel, or hardware like bolts, nuts, screws, nails, clips, pins, and/or dowels, to name a few. Fuselage 204 may also be configurable to accept certain specific cargo containers, or a receptable that can, in turn, accept certain cargo containers.

Still referring to FIG. 2, eVTOL 200 may include a plurality of laterally extending elements 208 attached to fuselage 204. As used in this disclosure a “laterally extending element” is an element that projects essentially horizontally from fuselage, including an outrigger, a spar, and/or a fixed wing that extends from fuselage. Wings may be structures which include airfoils configured to create a pressure differential resulting in lift. Wings may generally dispose on the left and right sides of the aircraft symmetrically, at a point between nose and empennage. Wings may comprise a plurality of geometries in planform view, swept swing, tapered, variable wing, triangular, oblong, elliptical, square, among others. A wing's cross section may geometry comprises an airfoil. An “airfoil” as used in this disclosure is a shape specifically designed such that a fluid flowing above and below it exert differing levels of pressure against the top and bottom surface. In embodiments, the bottom surface of an aircraft can be configured to generate a greater pressure than does the top, resulting in lift. In an embodiment, and without limitation, wing may include a leading edge. As used in this disclosure a “leading edge” is a foremost edge of an airfoil that first intersects with the external medium. For example, and without limitation, leading edge may include one or more edges that may comprise one or more characteristics such as sweep, radius and/or stagnation point, droop, thermal effects, and the like thereof. In an embodiment, and without limitation, wing may include a trailing edge. As used in this disclosure a “trailing edge” is a rear edge of an airfoil. In an embodiment, and without limitation, trailing edge may include an edge capable of controlling the direction of the departing medium from the wing, such that a controlling force is exerted on the aircraft. Laterally extending element 208 may comprise differing and/or similar cross-sectional geometries over its cord length or the length from wing tip to where wing meets the aircraft's body. One or more wings may be symmetrical about the aircraft's longitudinal plane, which comprises the longitudinal or roll axis reaching down the center of the aircraft through the nose and empennage, and the plane's yaw axis. Laterally extending element may comprise controls surfaces configured to be commanded by a pilot or pilots to change a wing's geometry and therefore its interaction with a fluid medium, like air. Control surfaces may comprise flaps, ailerons, tabs, spoilers, and slats, among others. The control surfaces may dispose on the wings in a plurality of locations and arrangements and in embodiments may be disposed at the leading and trailing edges of the wings, and may be configured to deflect up, down, forward, aft, or a combination thereof. An aircraft, including a dual-mode aircraft may comprise a combination of control surfaces to perform maneuvers while flying or on ground.

Still referring to FIG. 2, eVTOL 200 may include a plurality of lift components 212 attached to the plurality of extending elements 208. As used in this disclosure a “lift component” is a component and/or device used to propel a craft upward by exerting downward force on a fluid medium, which may include a gaseous medium such as air or a liquid medium such as water. Lift component 212 may include any device or component that consumes electrical power on demand to propel an electric aircraft in a direction or other vehicle while on ground or in-flight. For example, and without limitation, lift component 212 may include a rotor, propeller, paddle wheel and the like thereof, wherein a rotor is a component that produces torque along a longitudinal axis, and a propeller produces torquer along a vertical axis. In an embodiment, lift component 212 may include a propulsor. In an embodiment, when a propulsor twists and pulls air behind it, it will, at the same time, push an aircraft forward with an equal amount of force. As a further non-limiting example, lift component 212 may include a thrust element which may be integrated into the propulsor. The thrust element may include, without limitation, a device using moving or rotating foils, such as one or more rotors, an airscrew or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like. The more air pulled behind an aircraft, the greater the force with which the aircraft is pushed forward.

In an embodiment, and still referring to FIG. 2, lift component 212 may include a plurality of blades. As used in this disclosure a “blade” is a propeller that converts rotary motion from an engine or other power source into a swirling slipstream. In an embodiment, blade may convert rotary motion to push the propeller forwards or backwards. In an embodiment lift component 212 may include a rotating power-driven hub, to which are attached several radial airfoil-section blades such that the whole assembly rotates about a longitudinal axis. The blades may be configured at an angle of attack. In an embodiment, and without limitation, angle of attack may include a fixed angle of attack. As used in this disclosure an “fixed angle of attack” is fixed angle between the chord line of the blade and the relative wind. As used in this disclosure a “fixed angle” is an angle that is secured and/or unmovable from the attachment point. For example, and without limitation fixed angle of attack may be 2.8° as a function of a pitch angle of 8.1° and a relative wind angle 5.3°. In another embodiment, and without limitation, angle of attack may include a variable angle of attack. As used in this disclosure a “variable angle of attack” is a variable and/or moveable angle between the chord line of the blade and the relative wind. As used in this disclosure a “variable angle” is an angle that is moveable from the attachment point. For example, and without limitation variable angle of attack may be a first angle of 4.7° as a function of a pitch angle of 7.1° and a relative wind angle 2.4°, wherein the angle adjusts and/or shifts to a second angle of 2.7° as a function of a pitch angle of 5.1° and a relative wind angle 2.4°. In an embodiment, angle of attack be configured to produce a fixed pitch angle. As used in this disclosure a “fixed pitch angle” is a fixed angle between a cord line of a blade and the rotational velocity direction. For example, and without limitation, fixed pitch angle may include 18°. In another embodiment fixed angle of attack may be manually variable to a few set positions to adjust one or more lifts of the aircraft prior to flight. In an embodiment, blades for an aircraft are designed to be fixed to their hub at an angle similar to the thread on a screw makes an angle to the shaft; this angle may be referred to as a pitch or pitch angle which will determine the speed of the forward movement as the blade rotates.

In an embodiment, and still referring to FIG. 2, lift component 212 may be configured to produce a lift. As used in this disclosure a “lift” is a perpendicular force to the oncoming flow direction of fluid surrounding the surface. For example, and without limitation relative air speed may be horizontal to eVTOL 200, wherein the lift force may be a force exerted in the vertical direction, directing eVTOL 200 upwards. In an embodiment, and without limitation, lift component 212 may produce lift as a function of applying a torque to lift component. As used in this disclosure a “torque” is a measure of force that causes an object to rotate about an axis in a direction. For example, and without limitation, torque may rotate an aileron and/or rudder to generate a force that may adjust and/or affect altitude, airspeed velocity, groundspeed velocity, direction during flight, and/or thrust. In an embodiment, and without limitation, lift component 212 may receive a source of power and/or energy from a power sources may apply a torque on lift component 212 to produce lift. As used in this disclosure a “power source” is a source that that drives and/or controls any component attached to eVTOL 200. For example, and without limitation power source may include a motor that operates to move one or more lift components, to drive one or more blades, or the like thereof. A motor may be driven by direct current (DC) electric power and may include, without limitation, brushless DC electric motors, switched reluctance motors, induction motors, or any combination thereof. A motor may also include electronic speed controllers or other components for regulating motor speed, rotation direction, and/or dynamic braking.

Still referring to FIG. 2, power source may include an energy source. An energy source may include, for example, a generator, a photovoltaic device, a fuel cell such as a hydrogen fuel cell, direct methanol fuel cell, and/or solid oxide fuel cell, an electric energy storage device (e.g. a capacitor, an inductor, and/or a battery). An energy source may also include a battery cell, or a plurality of battery cells connected in series into a module and each module connected in series or in parallel with other modules. Configuration of an energy source containing connected modules may be designed to meet an energy or power requirement and may be designed to fit within a designated footprint in an electric aircraft in which eVTOL 200 may be incorporated.

In an embodiment, and still referring to FIG. 2, an energy source may be used to provide a steady supply of electrical power to a load over the course of a flight by a vehicle or other electric aircraft. For example, the energy source may be capable of providing sufficient power for “cruising” and other relatively low-energy phases of flight. An energy source may also be capable of providing electrical power for some higher-power phases of flight as well, particularly when the energy source is at a high SOC, as may be the case for instance during takeoff. In an embodiment, the energy source may be capable of providing sufficient electrical power for auxiliary loads including without limitation, lighting, navigation, communications, de-icing, steering or other systems requiring power or energy. Further, the energy source may be capable of providing sufficient power for controlled descent and landing protocols, including, without limitation, hovering descent or runway landing. As used herein the energy source may have high power density where the electrical power an energy source can usefully produce per unit of volume and/or mass is relatively high. The electrical power is defined as the rate of electrical energy per unit time. An energy source may include a device for which power that may be produced per unit of volume and/or mass has been optimized, at the expense of the maximal total specific energy density or power capacity, during design. Non-limiting examples of items that may be used as at least an energy source may include batteries used for starting applications including Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode, energy source may be used, in an embodiment, to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations, as described in further detail below. A battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. Persons skilled in the art, upon reviewing the entirety of this disclosure, will be aware of various devices of components that may be used as an energy source.

Still referring to FIG. 2, an energy source may include a plurality of energy sources, referred to herein as a module of energy sources. The module may include batteries connected in parallel or in series or a plurality of modules connected either in series or in parallel designed to deliver both the power and energy requirements of the application. Connecting batteries in series may increase the voltage of at least an energy source which may provide more power on demand. High voltage batteries may require cell matching when high peak load is needed. As more cells are connected in strings, there may exist the possibility of one cell failing which may increase resistance in the module and reduce the overall power output as the voltage of the module may decrease as a result of that failing cell. Connecting batteries in parallel may increase total current capacity by decreasing total resistance, and it also may increase overall amp-hour capacity. The overall energy and power outputs of at least an energy source may be based on the individual battery cell performance or an extrapolation based on the measurement of at least an electrical parameter. In an embodiment where the energy source includes a plurality of battery cells, the overall power output capacity may be dependent on the electrical parameters of each individual cell. If one cell experiences high self-discharge during demand, power drawn from at least an energy source may be decreased to avoid damage to the weakest cell. The energy source may further include, without limitation, wiring, conduit, housing, cooling system and battery management system. Persons skilled in the art will be aware, after reviewing the entirety of this disclosure, of many different components of an energy source.

Still referring to FIG. 2, eVTOL 200 may include at least a longitudinal thrust component 216. As used in this disclosure a “longitudinal thrust component” is a flight component that is mounted such that the component thrusts the flight component through a medium. As a non-limiting example, longitudinal thrust flight component 216 may include a pusher flight component such as a pusher propeller, a pusher motor, a pusher propulsor, and the like. Additionally, or alternatively, pusher flight component may include a plurality of pusher flight components. As a further non-limiting example, longitudinal thrust flight component may include a puller flight component such as a puller propeller, a puller motor, a puller propulsor, and the like. Additionally, or alternatively, puller flight component may include a plurality of puller flight components.

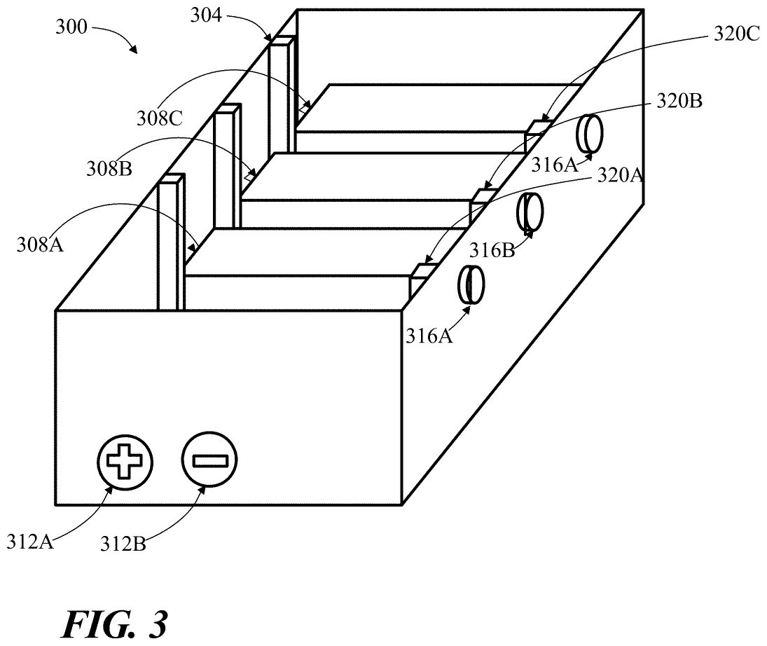

Referring now to the drawings, FIG. 3 illustrates an exemplary battery pack 300. Battery pack 400 may include any battery pack described in the entirety of this disclosure. For instance and without limitation, battery pack 300 may be consistent with battery pack in U.S. patent application Ser. No. 17/319,174 and titled “SYSTEMS AND METHODS OF USE FOR A BATTERY PACK ENCLOSURE,” which is incorporated by reference in its entirety. According to some embodiments, a battery pack 300 includes an outer case 304. In some cases, case 304 may be made from metal for example one or more of sheet metal, stamped metal, extruded metal, and/or machined metal. In some cases, case 304 may be formed by way of welding, brazing, and/or soldering. In some cases, case 304 may be composed wholly or in part of a relatively light and strong metal, such as without limitation aluminum alloy. As shown in FIG. 3, case 304, may include an outer case, which may substantially enclose a plurality of battery modules 308A-C. In some versions, case may provide a firewall between flammable battery modules within battery pack and an environment or vehicle surrounding the battery pack.

Continuing in reference to FIG. 3, Battery modules 308A-C may include any battery modules or battery cells described throughout this disclosure, for instance without limitation those described below. Typically, battery modules 308A-C are connected in series to one another, such that a total potential for all of the battery modules together is greater than a potential for any one of the battery modules (e.g., 308A). In some cases, a shared electrical connection from plurality of modules 308A-C may be accessible by way of an electrical connector 312A-B. In some cases, the electrical connector 312A-B may have a polarity and include a positive connection 312A and a negative connection 312B. In some cases, one or more battery modules of plurality of battery modules 308A-C may be mounted to case 304 by way of at least a breakaway mount 316A-C. In some embodiments, a breakaway mount may include any means for attachment that is configured to disconnect under a predetermined load. In some cases, breakaway mounts may be passive and rely upon loading forces for disconnection, such as exemplary breakaway mounts which may include one or more of a shear pin, a frangible nut, a frangible bolt, a breakaway nut, bolt, or stud, and the like. In some cases, a passive breakaway mount may include a relatively soft or brittle material (e.g., plastic) which is easily broken under achievable loads. Alternatively or additionally, a breakaway mount may include a notch, a score line, or another weakening feature purposefully introduced to the mount to introduce breaking at a prescribed load. According to some embodiments, a canted coil spring may be used to as part of a breakaway mount, to ensure that the mount disconnects under a predetermined loading condition. In some cases a mount may comprise a canted coil spring, a housing, and a piston; and sizes and profiles of the housing and the piston may be selected in order to prescribe a force required to disconnect the mount. An exemplary canted coil spring may be provided by Bal-Seal Engineering, Inc. of Foothill Ranch, Calif., U.S.A. Alternatively or additionally, a breakaway mount may include an active feature which is configured to actively disconnect a mount under a prescribed condition (for instance a rapid change in elevation or large measured G-forces). Much like an airbag that is configured to activate during a crash, an active mount may be configured to actively disconnect during a sensed crash. An active mount may, in some cases, include one or more of an explosive bolt, an explosive nut, an electro-magnetic connection, and the like. In some cases, one or more breakaway mounts 316A-C may be configured to disconnect under a certain loading condition, for instance a force in excess of a predetermined threshold (i.e., battery breakaway force) acting substantially along (e.g., within about +/−45°) a predetermined direction. Non-limiting exemplary battery breakaway forces may include decelerations in excess of 4, 32, 20, 50, or 300 G's.

In some embodiments, a case 304 circumscribes an inner volume, which may include a battery storage zone, for instance within which battery modules 308A-C are located, and a crush zone. As a non-limiting example, crush zone may be located between one or more battery modules 308A-C and an inner wall of case 304. In some embodiments, crush zone may be substantially empty. Alternatively, in some other embodiments, crush zone may comprise some material, such as without limitation a compressible material. In some cases, compressible material may be configured to absorb and/or dissipate energy as it is compressed. In some cases, compressible material may include a material having a number of voids; for instance, compressible material may take a form of a honeycomb or another predictably cellular form. Alternatively or additionally, compressible material may include a non-uniform material, such as without limitation a foam. In some embodiments, a crush zone may be located down from one or more battery modules 308A-C substantially along a loading direction, such that for instance the one or more battery modules when disconnected from one or more breakaway mounts 316A-C may be directed toward crush zone. In some cases, case 304 may include one or more channels or guides 320A-C configured to direct at least a battery module 308A-C into a crush zone, should it become disconnected from the case.

Still referring to FIG. 3, in some embodiments, battery module 308A-C may include Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon, tin nanocrystals, graphite, graphene or titanate anode, or the like. Batteries and/or battery modules may include without limitation batteries using nickel-based chemistries such as nickel cadmium or nickel metal hydride, batteries using lithium-ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), batteries using lithium polymer technology, metal-air batteries. Battery modules 308A-C may include lead-based batteries such as without limitation lead acid batteries and lead carbon batteries. Battery modules 308A-C may include lithium sulfur batteries, magnesium ion batteries, and/or sodium ion batteries. Batteries may include solid state batteries or supercapacitors or another suitable energy source. Batteries may be primary or secondary or a combination of both. Additional disclosure related to batteries and battery modules may be found in co-owned U.S. patent applications entitled “SYSTEM AND METHOD FOR HIGH ENERGY DENSITY BATTERY MODULE” and “SYSTEMS AND METHODS FOR RESTRICTING POWER TO A LOAD TO PREVENT ENGAGING CIRCUIT PROTECTION DEVICE FOR AN AIRCRAFT,” having U.S. patent application Ser. Nos. 16/948,140 and 16/590,496 respectively; the entirety of both applications is incorporated herein by reference. Persons skilled in the art, upon reviewing the entirety of this disclosure, will be aware of various devices of components that may be used as a battery module. In some cases, case 304 is constructed in a manner that maximizes manufacturing efficiencies.

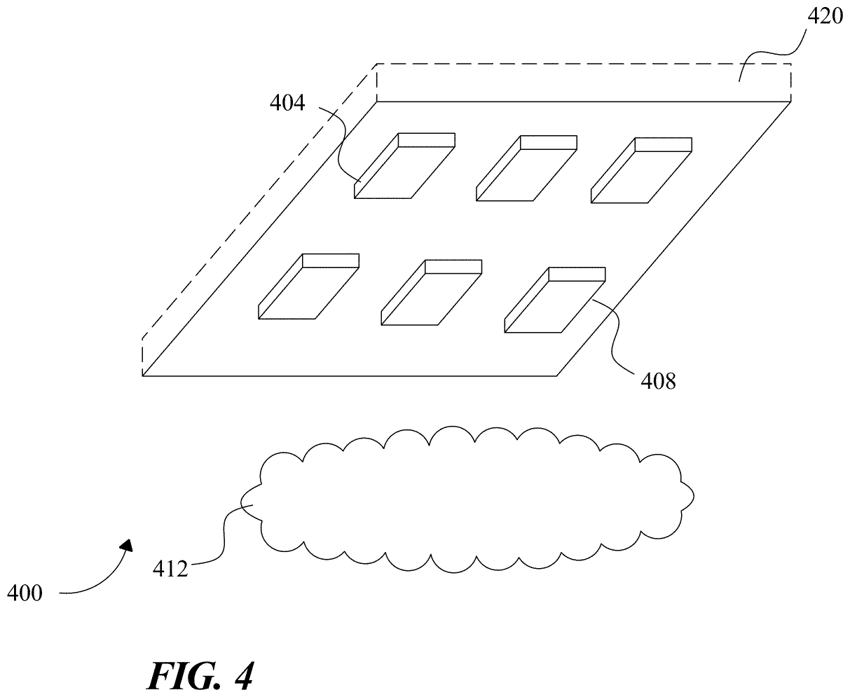

Referring now to FIG. 4, an embodiment of sensor suite 400 is presented. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In a non-limiting example, there may be four independent sensors housed in and/or on each battery pack of plurality of battery packs 112 measuring temperature, electrical characteristic such as voltage, amperage, resistance, or impedance, or any other parameters and/or quantities as described in this disclosure. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of battery management system 400 and/or user to detect phenomenon is maintained and in a non-limiting example, a user alter aircraft usage pursuant to sensor readings.

With continued reference to FIG. 4, sensor suite 400 includes a moisture sensor 404. “Moisture”, as used in this disclosure, is the presence of water, this may include vaporized water in air, condensation on the surfaces of objects, or concentrations of liquid water. Moisture may include humidity. “Humidity”, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. Moisture sensor 404 may be psychrometer. Moisture sensor 404 may be a hygrometer. Moisture sensor 404 may be configured to act as or include a humidistat. A “humidistat”, for the purposes of this disclosure, is a humidity-triggered switch, often used to control another electronic device. Moisture sensor 404 may use capacitance to measure relative humidity and include in itself, or as an external component, include a device to convert relative humidity measurements to absolute humidity measurements. “Capacitance”, for the purposes of this disclosure, is the ability of a system to store an electric charge, in this case the system is a parcel of air which may be near, adjacent to, or above a battery cell.

With continued reference to FIG. 4, sensor suite 400 may include electrical sensors 408. Electrical sensors 408 may be configured to measure voltage across a component, electrical current through a component, and resistance of a component. Electrical sensors 408 may include separate sensors to measure each of the previously disclosed electrical characteristics such as voltmeter, ammeter, and ohmmeter, respectively.

Alternatively or additionally, and with continued reference to FIG. 4, sensor suite 400 include a sensor or plurality thereof that may detect voltage and direct the charging of individual battery cells according to charge level; detection may be performed using any suitable component, set of components, and/or mechanism for direct or indirect measurement and/or detection of voltage levels, including without limitation comparators, analog to digital converters, any form of voltmeter, or the like. Sensor suite 400 and/or a control circuit incorporated therein and/or communicatively connected thereto may be configured to adjust charge to one or more battery cells as a function of a charge level and/or a detected parameter. For instance, and without limitation, sensor suite 400 may be configured to determine that a charge level of a battery cell is high based on a detected voltage level of that battery cell or portion of the battery pack. Sensor suite 400 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of the cell above a threshold level, detection of a voltage and/or resistance level above or below a threshold, or the like. Sensor suite 400 may include digital sensors, analog sensors, or a combination thereof. Sensor suite 400 may include digital-to-analog converters (DAC), analog-to-digital converters (ADC, A/D, A-to-D), a combination thereof, or other signal conditioning components used in transmission of a first plurality of battery pack data 428 to a destination over wireless or wired connection.

With continued reference to FIG. 4, sensor suite 400 may include thermocouples, thermistors, thermometers, passive infrared sensors, resistance temperature sensors (RTD's), semiconductor based integrated circuits (IC), a combination thereof or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor suite 400, may be measured in Fahrenheit (° F.), Celsius (° C.), Kelvin (° K), or another scale alone or in combination. The temperature measured by sensors may comprise electrical signals which are transmitted to their appropriate destination wireless or through a wired connection.

With continued reference to FIG. 4, sensor suite 400 may include a sensor configured to detect gas that may be emitted during or after a cell failure. “Cell failure”, for the purposes of this disclosure, refers to a malfunction of a battery cell, which may be an electrochemical cell, that renders the cell inoperable for its designed function, namely providing electrical energy to at least a portion of an electric aircraft. Byproducts of cell failure 412 may include gaseous discharge including oxygen, hydrogen, carbon dioxide, methane, carbon monoxide, a combination thereof, or another undisclosed gas, alone or in combination. Further the sensor configured to detect vent gas from electrochemical cells may comprise a gas detector. For the purposes of this disclosure, a “gas detector” is a device used to detect a gas is present in an area. Gas detectors, and more specifically, the gas sensor that may be used in sensor suite 400, may be configured to detect combustible, flammable, toxic, oxygen depleted, a combination thereof, or another type of gas alone or in combination. The gas sensor that may be present in sensor suite 400 may include a combustible gas, photoionization detectors, electrochemical gas sensors, ultrasonic sensors, metal-oxide-semiconductor (MOS) sensors, infrared imaging sensors, a combination thereof, or another undisclosed type of gas sensor alone or in combination. Sensor suite 400 may include sensors that are configured to detect non-gaseous byproducts of cell failure 412 including, in non-limiting examples, liquid chemical leaks including aqueous alkaline solution, ionomer, molten phosphoric acid, liquid electrolytes with redox shuttle and ionomer, and salt water, among others. Sensor suite 400 may include sensors that are configured to detect non-gaseous byproducts of cell failure 412 including, in non-limiting examples, electrical anomalies as detected by any of the previous disclosed sensors or components.

With continued reference to FIG. 4, sensor suite 400 may be configured to detect events where voltage nears an upper voltage threshold or lower voltage threshold. The upper voltage threshold may be stored in data storage device for comparison with an instant measurement taken by any combination of sensors present within sensor suite 400. The upper voltage threshold may be calculated and calibrated based on factors relating to battery cell health, maintenance history, location within battery pack, designed application, and type, among others. Sensor suite 400 may measure voltage at an instant, over a period of time, or periodically. Sensor suite 400 may be configured to operate at any of these detection modes, switch between modes, or simultaneous measure in more than one mode. First battery management component 404 may detect through sensor suite 400 events where voltage nears the lower voltage threshold. The lower voltage threshold may indicate power loss to or from an individual battery cell or portion of the battery pack. First battery management component 404 may detect through sensor suite 400 events where voltage exceeds the upper and lower voltage threshold. Events where voltage exceeds the upper and lower voltage threshold may indicate battery cell failure or electrical anomalies that could lead to potentially dangerous situations for aircraft and personnel that may be present in or near its operation.

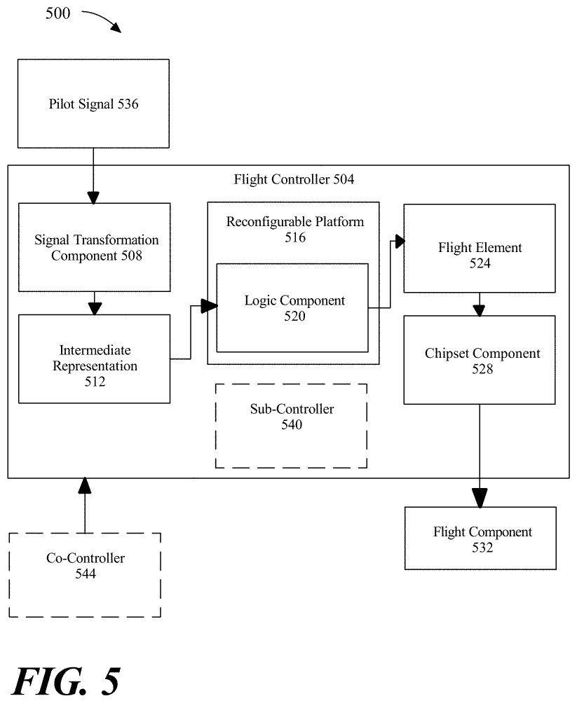

Now referring to FIG. 5, an exemplary embodiment 500 of a flight controller 504 is illustrated. As used in this disclosure a “flight controller” is a computing device of a plurality of computing devices dedicated to data storage, security, distribution of traffic for load balancing, and flight instruction. Flight controller 504 may include and/or communicate with any computing device as described in this disclosure, including without limitation a microcontroller, microprocessor, digital signal processor (DSP) and/or system on a chip (SoC) as described in this disclosure. Further, flight controller 504 may include a single computing device operating independently, or may include two or more computing device operating in concert, in parallel, sequentially or the like; two or more computing devices may be included together in a single computing device or in two or more computing devices. In embodiments, flight controller 504 may be installed in an aircraft, may control the aircraft remotely, and/or may include an element installed in the aircraft and a remote element in communication therewith.

In an embodiment, and still referring to FIG. 5, flight controller 504 may include a signal transformation component 508. As used in this disclosure a “signal transformation component” is a component that transforms and/or converts a first signal to a second signal, wherein a signal may include one or more digital and/or analog signals. For example, and without limitation, signal transformation component 508 may be configured to perform one or more operations such as preprocessing, lexical analysis, parsing, semantic analysis, and the like thereof. In an embodiment, and without limitation, signal transformation component 508 may include one or more analog-to-digital convertors that transform a first signal of an analog signal to a second signal of a digital signal. For example, and without limitation, an analog-to-digital converter may convert an analog input signal to an 8-bit binary digital representation of that signal. In another embodiment, signal transformation component 508 may include transforming one or more low-level languages such as, but not limited to, machine languages and/or assembly languages. For example, and without limitation, signal transformation component 508 may include transforming a binary language signal to an assembly language signal. In an embodiment, and without limitation, signal transformation component 508 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 5, signal transformation component 508 may be configured to optimize an intermediate representation 512. As used in this disclosure an “intermediate representation” is a data structure and/or code that represents the input signal. Signal transformation component 508 may optimize intermediate representation as a function of a data-flow analysis, dependence analysis, alias analysis, pointer analysis, escape analysis, and the like thereof. In an embodiment, and without limitation, signal transformation component 508 may optimize intermediate representation 512 as a function of one or more inline expansions, dead code eliminations, constant propagation, loop transformations, and/or automatic parallelization functions. In another embodiment, signal transformation component 508 may optimize intermediate representation as a function of a machine dependent optimization such as a peephole optimization, wherein a peephole optimization may rewrite short sequences of code into more efficient sequences of code. Signal transformation component 508 may optimize intermediate representation to generate an output language, wherein an “output language,” as used herein, is the native machine language of flight controller 504. For example, and without limitation, native machine language may include one or more binary and/or numerical languages.

In an embodiment, and without limitation, signal transformation component 508 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 5, flight controller 504 may include a reconfigurable hardware platform 516. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 516 may be reconfigured to enact any algorithm and/or algorithm selection process received from another computing device and/or created using machine-learning processes.

Still referring to FIG. 5, reconfigurable hardware platform 516 may include a logic component 520. As used in this disclosure a “logic component” is a component that executes instructions on output language. For example, and without limitation, logic component may perform basic arithmetic, logic, controlling, input/output operations, and the like thereof. Logic component 520 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 520 may be organized according to Von Neumann and/or Harvard architecture as a non-limiting example. Logic component 520 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC). In an embodiment, logic component 520 may include one or more integrated circuit microprocessors, which may contain one or more central processing units, central processors, and/or main processors, on a single metal-oxide-semiconductor chip. Logic component 520 may be configured to execute a sequence of stored instructions to be performed on the output language and/or intermediate representation 512. Logic component 520 may be configured to fetch and/or retrieve the instruction from a memory cache, wherein a “memory cache,” as used in this disclosure, is a stored instruction set on flight controller 504. Logic component 520 may be configured to decode the instruction retrieved from the memory cache to opcodes and/or operands. Logic component 520 may be configured to execute the instruction on intermediate representation 512 and/or output language. For example, and without limitation, logic component 520 may be configured to execute an addition operation on intermediate representation 512 and/or output language.

In an embodiment, and without limitation, logic component 520 may be configured to calculate a flight element 524. As used in this disclosure a “flight element” is an element of datum denoting a relative status of aircraft. For example, and without limitation, flight element 524 may denote one or more torques, thrusts, airspeed velocities, forces, altitudes, groundspeed velocities, directions during flight, directions facing, forces, orientations, and the like thereof. For example, and without limitation, flight element 524 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 524 may denote that aircraft is following a flight path accurately and/or sufficiently.

Still referring to FIG. 5, flight controller 504 may include a chipset component 528. As used in this disclosure a “chipset component” is a component that manages data flow. In an embodiment, and without limitation, chipset component 528 may include a northbridge data flow path, wherein the northbridge dataflow path may manage data flow from logic component 520 to a high-speed device and/or component, such as a RAM, graphics controller, and the like thereof. In another embodiment, and without limitation, chipset component 528 may include a southbridge data flow path, wherein the southbridge dataflow path may manage data flow from logic component 520 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 528 may manage data flow between logic component 520, memory cache, and a flight component 532. As used in this disclosure a “flight component” is a portion of an aircraft that can be moved or adjusted to affect one or more flight elements. For example, flight component 532 may include a component used to affect the aircrafts' roll and pitch which may comprise one or more ailerons. As a further example, flight component 532 may include a rudder to control yaw of an aircraft. In an embodiment, chipset component 528 may be configured to communicate with a plurality of flight components as a function of flight element 524. For example, and without limitation, chipset component 528 may transmit to an aircraft rotor to reduce torque of a first lift propulsor and increase the forward thrust produced by a pusher component to perform a flight maneuver.

In an embodiment, and still referring to FIG. 5, flight controller 504 may be configured generate an autonomous function. As used in this disclosure an “autonomous function” is a mode and/or function of flight controller 504 that controls aircraft automatically. For example, and without limitation, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 524. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 504 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 504 will control the ailerons and/or rudders. As used in this disclosure “non-autonomous mode” is a mode that denotes a pilot will control aircraft and/or maneuvers of aircraft in its entirety.

In an embodiment, and still referring to FIG. 5, flight controller 504 may generate autonomous function as a function of an autonomous machine-learning model. As used in this disclosure an “autonomous machine-learning model” is a machine-learning model to produce an autonomous function output given flight element 524 and a pilot signal 536 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 536 may denote that a pilot is controlling and/or maneuvering ailerons, wherein the pilot is not in control of the rudders and/or propulsors. In an embodiment, pilot signal 536 may include an implicit signal and/or an explicit signal. For example, and without limitation, pilot signal 536 may include an explicit signal, wherein the pilot explicitly states there is a lack of control and/or desire for autonomous function. As a further non-limiting example, pilot signal 536 may include an explicit signal directing flight controller 504 to control and/or maintain a portion of aircraft, a portion of the flight plan, the entire aircraft, and/or the entire flight plan. As a further non-limiting example, pilot signal 536 may include an implicit signal, wherein flight controller 504 detects a lack of control such as by a malfunction, torque alteration, flight path deviation, and the like thereof. In an embodiment, and without limitation, pilot signal 536 may include one or more explicit signals to reduce torque, and/or one or more implicit signals that torque may be reduced due to reduction of airspeed velocity. In an embodiment, and without limitation, pilot signal 536 may include one or more local and/or global signals. For example, and without limitation, pilot signal 536 may include a local signal that is transmitted by a pilot and/or crew member. As a further non-limiting example, pilot signal 536 may include a global signal that is transmitted by air traffic control and/or one or more remote users that are in communication with the pilot of aircraft. In an embodiment, pilot signal 536 may be received as a function of a tri-state bus and/or multiplexor that denotes an explicit pilot signal should be transmitted prior to any implicit or global pilot signal.

Still referring to FIG. 5, autonomous machine-learning model may include one or more autonomous machine-learning processes such as supervised, unsupervised, or reinforcement machine-learning processes that flight controller 504 and/or a remote device may or may not use in the generation of autonomous function. As used in this disclosure “remote device” is an external device to flight controller 504. Additionally or alternatively, autonomous machine-learning model may include one or more autonomous machine-learning processes that a field-programmable gate array (FPGA) may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 5, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Flight controller 504 may receive autonomous training data by receiving correlations of flight element, pilot signal, and/or simulation data to an autonomous function that were previously received and/or determined during a previous iteration of generation of autonomous function. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 5, flight controller 504 may receive autonomous machine-learning model from a remote device and/or FPGA that utilizes one or more autonomous machine learning processes, wherein a remote device and an FPGA is described above in detail. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 504. Remote device and/or FPGA may transmit a signal, bit, datum, or parameter to flight controller 504 that at least relates to autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 504 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 5, flight controller 504 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 5, flight controller 504 may include, but is not limited to, for example, a cluster of flight controllers in a first location and a second flight controller or cluster of flight controllers in a second location. Flight controller 504 may include one or more flight controllers dedicated to data storage, security, distribution of traffic for load balancing, and the like. Flight controller 504 may be configured to distribute one or more computing tasks as described below across a plurality of flight controllers, which may operate in parallel, in series, redundantly, or in any other manner used for distribution of tasks or memory between computing devices. For example, and without limitation, flight controller 504 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Mass., USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 5, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 532. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 5, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 504. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 512 and/or output language from logic component 520, wherein output language may include one or more analog-to-digital conversions, low bit rate transmissions, message encryptions, digital signals, binary signals, logic signals, analog signals, and the like thereof described above in detail.

Still referring to FIG. 5, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 5, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 5, flight controller 504 may also be implemented using a “shared nothing” architecture in which data is cached at the worker, in an embodiment, this may enable scalability of aircraft and/or computing device. Flight controller 504 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 5, a node may include, without limitation, a plurality of inputs xᵢ that may receive numerical values from inputs to a neural network containing the node and/or from other nodes. Node may perform a weighted sum of inputs using weights wᵢ that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. In an embodiment, and without limitation, a neural network may receive semantic units as inputs and output vectors representing such semantic units according to weights wᵢ that are derived using machine-learning processes as described in this disclosure.

Still referring to FIG. 5, flight controller may include a sub-controller 840. As used in this disclosure a “sub-controller” is a controller and/or component that is part of a distributed controller as described above; for instance, flight controller 504 may be and/or include a distributed flight controller made up of one or more sub-controllers. For example, and without limitation, sub-controller 840 may include any controllers and/or components thereof that are similar to distributed flight controller and/or flight controller as described above. Sub-controller 840 may include any component of any flight controller as described above. Sub-controller 840 may be implemented in any manner suitable for implementation of a flight controller as described above. As a further non-limiting example, sub-controller 840 may include one or more processors, logic components and/or computing devices capable of receiving, processing, and/or transmitting data across the distributed flight controller as described above. As a further non-limiting example, sub-controller 840 may include a controller that receives a signal from a first flight controller and/or first distributed flight controller component and transmits the signal to a plurality of additional sub-controllers and/or flight components.

Still referring to FIG. 5, flight controller may include a co-controller 844. As used in this disclosure a “co-controller” is a controller and/or component that joins flight controller 504 as components and/or nodes of a distributer flight controller as described above. For example, and without limitation, co-controller 844 may include one or more controllers and/or components that are similar to flight controller 504. As a further non-limiting example, co-controller 844 may include any controller and/or component that joins flight controller 504 to distributer flight controller. As a further non-limiting example, co-controller 844 may include one or more processors, logic components and/or computing devices capable of receiving, processing, and/or transmitting data to and/or from flight controller 504 to distributed flight control system. Co-controller 844 may include any component of any flight controller as described above. Co-controller 844 may be implemented in any manner suitable for implementation of a flight controller as described above. In an embodiment, and with continued reference to FIG. 5, flight controller 504 may be designed and/or configured to perform any method, method step, or sequence of method steps in any embodiment described in this disclosure, in any order and with any degree of repetition. For instance, flight controller 504 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

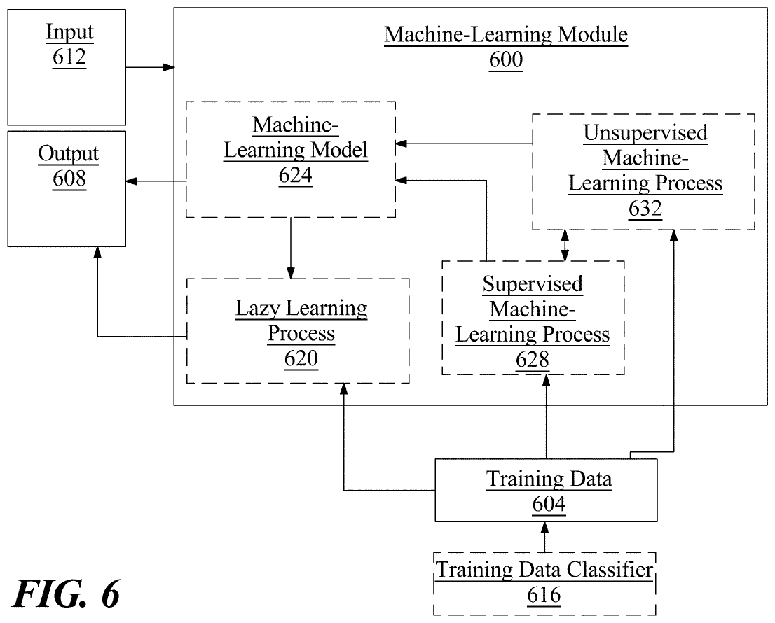

Referring now to FIG. 6, an exemplary embodiment of a machine-learning module 600 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 604 to generate an algorithm that will be performed by a computing device/module to produce outputs 608 given data provided as inputs 612; this is in contrast to a non-machine learning software program where the commands to be executed are determined in advance by a user and written in a programming language.

Still referring to FIG. 6, “training data,” as used herein, is data containing correlations that a machine-learning process may use to model relationships between two or more categories of data elements. For instance, and without limitation, training data 604 may include a plurality of data entries, each entry representing a set of data elements that were recorded, received, and/or generated together; data elements may be correlated by shared existence in a given data entry, by proximity in a given data entry, or the like. Multiple data entries in training data 604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations; correlations may indicate causative and/or predictive links between categories of data elements, which may be modeled as relationships such as mathematical relationships by machine-learning processes as described in further detail below. Training data 604 may be formatted and/or organized by categories of data elements, for instance by associating data elements with one or more descriptors corresponding to categories of data elements. As a non-limiting example, training data 604 may include data entered in standardized forms by persons or processes, such that entry of a given data element in a given field in a form may be mapped to one or more descriptors of categories. Elements in training data 604 may be linked to descriptors of categories by tags, tokens, or other data elements; for instance, and without limitation, training data 604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 6, training data 604 may include one or more elements that are not categorized; that is, training data 604 may not be formatted or contain descriptors for some elements of data. Machine-learning algorithms and/or other processes may sort training data 604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure.

Further referring to FIG. 6, training data may be filtered, sorted, and/or selected using one or more supervised and/or unsupervised machine-learning processes and/or models as described in further detail below; such models may include without limitation a training data classifier 616. Training data classifier 616 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 600 may generate a classifier using a classification algorithm, defined as a processes whereby a computing device and/or any module and/or component operating thereon derives a classifier from training data 604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 616 may classify elements of training data to battery pack diagnostic datum, optimal battery pack combination, and the like thereof.

Still referring to FIG. 6, machine-learning module 600 may be configured to perform a lazy-learning process 620 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively, or additionally, and with continued reference to FIG. 6, machine-learning processes as described in this disclosure may be used to generate machine-learning models 624. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include at least a supervised machine-learning process 628. At least a supervised machine-learning process 628, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include battery pack status data of plurality of battery packs as described above as inputs, battery pack diagnostic datum as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 628 that may be used to determine relation between inputs and outputs. Supervised machine-learning processes may include classification algorithms as defined above.

Further referring to FIG. 6, machine learning processes may include at least an unsupervised machine-learning processes 632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Now referring to FIG. 7, a flow diagram of an exemplary method 700 for A method for determining a suitable battery pack combination configured for use in an electric aircraft is illustrated. Electric aircraft includes a plurality of battery packs, wherein each battery pack including at least a battery module containing at least a battery cell, and at least a sensor configured to detect battery pack status data corresponding to the plurality of battery packs.

With continued reference to FIG. 7, Method 700 includes a step 705 of receiving, by at least a processor, battery pack status data for each battery pack of plurality of battery packs. In some embodiments, the battery pack status data may include battery pack health data of the plurality of battery packs. In some embodiments, the battery pack status data may include internal state data and external state data of the plurality of battery packs. In some embodiments, receiving the battery pack status data may include receiving battery pack status data from a battery pack model associated with the battery pack. This may be implemented, without limitation, as described above with reference to FIGS. 1-6.

With continued reference to FIG. 7, method 700 includes a step 710 of generating, by the at least a processor, a battery pack diagnostic datum for each battery pack of the plurality of battery packs as a function of the battery pack status data of each battery pack of the plurality of battery packs. In some embodiments, the battery pack diagnostic datum may include an efficiency factor. In some embodiments, the battery pack diagnostic datum may include a safety factor. In some embodiments, step 715 of generating the battery pack diagnostic datum may include modeling a battery pack status model as a function of the battery pack status data and generating the battery pack diagnostic datum for each battery pack of the plurality of battery packs as a function of the battery pack status model. In other embodiments, step 715 of generating the battery pack diagnostic datum may include training a battery pack diagnostic machine-learning model using battery pack training data, wherein the battery pack training data comprises a plurality of battery pack data as input correlated to a plurality of battery pack diagnostic data as output and generate the battery pack diagnostic datum for each battery pack of the plurality of battery packs as a function of the battery pack diagnostic machine-learning model. This may be implemented, without limitation, as described above with reference to FIGS. 1-6.

With continued reference to FIG. 7, method 700 includes a step 715 of determining, by the at least a processor, a suitability of the plurality of battery packs as a function of each battery pack diagnostic datum for each battery pack of the plurality of battery packs. This may be implemented, without limitation, as described above with reference to FIGS. 1-6.

With continued reference to FIG. 7, method 700 may further include a step of determining an optimal battery pack combination as a function of the battery pack diagnostic datum. In some embodiments, determining the optimal battery pack combination may include generating a flight simulation as a function of the optimal battery pack combination. Generating the flight simulation may include simulating a performance of the electric aircraft as a function of a mission profile, outputting a flight simulation feedback as a function of the performance of the electric aircraft, and determining the optimal battery pack combination as a function of the flight simulation feedback. In some embodiments, determining the optimal battery pack combination may include identifying at least a battery pack of the plurality of battery packs for replacement as a function of the optimal battery pack combination. This may be implemented, without limitation, as described above with reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

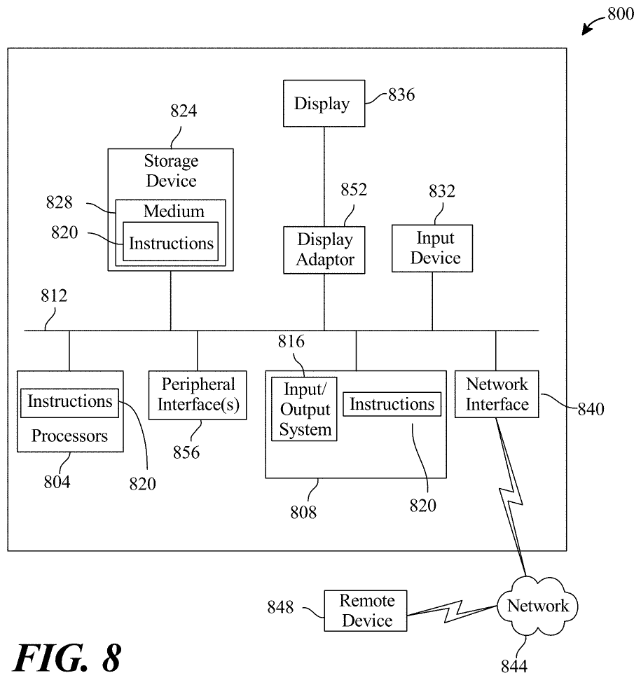

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for determining a suitable battery pack combination configured for use in an electric aircraft, the system comprising:
at least a processor communicatively connected to at least a sensor; and
a memory communicatively connected to the at least a processor, the memory containing instructions configuring the at least a processor to:
for each battery pack of a plurality of battery packs, receive a battery pack status data associated with the battery pack;
generate a battery pack diagnostic datum for each battery pack of the plurality of battery packs as a function of the battery pack status data of each battery pack of the plurality of battery packs; and
determine a suitability of the plurality of battery packs as a function of each battery pack diagnostic datum for each battery pack of the plurality of battery packs.

2. The system of claim 1, wherein the battery pack status data comprises battery pack health data for the plurality of battery packs.

3. The system of claim 1, wherein the battery pack status data comprises internal state data and external state data for the plurality of battery packs.

4. The system of claim 1, wherein the battery pack diagnostic datum comprises one or more of an efficiency factor and a safety factor.

5. The system of claim 1, wherein receiving the battery pack status data, comprises receiving the battery pack status data from a battery pack model associated with the battery pack.

6. The system of claim 1, wherein generating the battery pack diagnostic datum comprises:
modeling a battery pack status model as a function of the battery pack status data; and
generating the battery pack diagnostic datum for each battery pack of the plurality of battery packs as a function of the battery pack status model.

7. The system of claim 1, wherein generating the battery pack diagnostic datum comprises:
training a battery pack diagnostic machine-learning model using battery pack training data, wherein the battery pack training data comprises a plurality of battery pack data as input correlated to a plurality of battery pack diagnostic data as output; and
generate the battery pack diagnostic datum for each battery pack of the plurality of battery packs as a function of the battery pack diagnostic machine-learning model.

8. The system of claim 1, wherein the memory further contains instructions configuring the at least a processor to:
determine an optimal battery pack combination as a function of the battery pack diagnostic datum.

9. The system of claim 8, wherein determining the optimal battery pack combination comprises:
generating a flight simulation as a function of the optimal battery pack combination, wherein the generating the flight simulation comprises:
simulating a performance of the electric aircraft as a function of a mission profile;
outputting a flight simulation feedback as a function of the performance of the electric aircraft; and
determining the optimal battery pack combination as a function of the flight simulation feedback.

10. The system of claim 8, wherein determining the optimal battery pack combination comprises identifying at least a battery pack of the plurality of battery packs for replacement as a function of the optimal battery pack combination.

11. A method for determining an suitable battery pack combination configured for use in an electric aircraft, the method comprising:
receiving, by the at least a processor, a battery pack status data for each battery pack of a plurality of battery packs;
generating, by the at least a processor, a battery pack diagnostic datum for each battery pack of the plurality of battery packs as a function of the battery pack status data of each battery pack of the plurality of battery packs; and
determining, by the at least a processor, a suitability of the plurality of battery packs as a function of each battery pack diagnostic datum for each battery pack of the plurality of battery packs.

12. The method of claim 11, wherein the battery pack status data comprises battery pack health data of the plurality of battery packs.

13. The method of claim 11, wherein the battery pack status data comprises internal state data and external state data of the plurality of battery packs.

14. The method of claim 11, wherein the battery pack diagnostic datum comprises one or more of an efficiency factor and a safety factor.

15. The method of claim 11, wherein receiving the battery pack status data, comprises receiving the battery pack status data from a battery pack model associated with the battery pack.

16. The method of claim 11, wherein generating the battery pack diagnostic datum comprises:
modeling a battery pack status model as a function of the battery pack status data; and
generating the battery pack diagnostic datum for each battery pack of the plurality of battery packs as a function of the battery pack status model.

17. The method of claim 11, wherein generating the battery pack diagnostic datum comprises:
training a battery pack diagnostic machine-learning model using battery pack training data, wherein the battery pack training data comprises a plurality of battery pack data as input correlated to a plurality of battery pack diagnostic data as output; and
generate the battery pack diagnostic datum for each battery pack of the plurality of battery packs as a function of the battery pack diagnostic machine-learning model.

18. The method of claim 11, wherein the memory further contains instructions configuring the at least a processor to:
determine an optimal battery pack combination as a function of the battery pack diagnostic datum.

19. The method of claim 18, wherein determining the optimal battery pack combination comprises:
generating a flight simulation as a function of the optimal battery pack combination, wherein the generating the flight simulation comprises:
simulating a performance of the electric aircraft as a function of a mission profile;
outputting a flight simulation feedback as a function of the performance of the electric aircraft; and
determining the optimal battery pack combination as a function of the flight simulation feedback.

20. The method of claim 18, wherein determining the optimal battery pack combination comprises identifying at least a battery pack of the plurality of battery packs for replacement as a function of the optimal battery pack combination.
